(19) United States
(12) Patent Application Publication
(10) Pub. No.: US 2026/0292336 A1
(43) Pub. Date: Sep. 24, 2026

(54) FOCUS CONTROL DEVICE, OPERATION METHOD OF FOCUS CONTROL DEVICE, OPERATION PROGRAM OF FOCUS CONTROL DEVICE, AND IMAGING DEVICE

(71) Applicant: FUJIFILM Corporation, Tokyo (JP)

(72) Inventor: Hinako SUZUKI, Saitama (JP)

(73) Assignee: FUJIFILM Corporation, Tokyo (JP)

(21) Appl. No.: 19/561,476

(22) Filed: Mar. 9, 2026

(30) Foreign Application Priority Data
Mar. 21, 2025 (JP) 2025-047078

(51) Int. Cl. H04N 23/67; H04N 25/704

(52) U.S. Cl. CPC H04N 23/672; H04N 25/704

(57) ABSTRACT

A determination unit calculates a difference for a plurality of phase-difference detection pixels arranged in a focus detection region, the difference being a difference between a pixel value of a reference pixel and a pixel value of a neighboring pixel present within a preset neighboring range from the reference pixel. A detection unit determines a detection method of a focus position of a focus lens in accordance with the difference.

### CROSS-REFERENCE TO RELATED APPLICATIONS

The present application claims priority under 35 U.S.C. § 119 to Japanese Patent Application No. 2025-047078, filed on Mar. 21, 2025. The above application is hereby expressly incorporated by reference, in its entirety, into the present application.

### BACKGROUND

### 1. Technical Field

The technology of the present disclosure relates to a focus control device, an operation method of a focus control device, an operation program of a focus control device, and an imaging device.

### 2. Description of the Related Art

WO2015/146228A discloses an imaging device comprising an imaging element having an imaging surface in which a plurality of signal detection units are two-dimensionally arranged in a row direction and a column direction orthogonal to the row direction, in which the plurality of signal detection units include a first signal detection unit, a second signal detection unit, and a third signal detection unit.

The first signal detection unit detects a signal corresponding to a luminous flux that has passed through one split region of a pupil region of an imaging optical system, which is split in the row direction. The second signal detection unit detects a signal corresponding to a luminous flux that has passed through the other split region. The third signal detection unit detects a signal corresponding to a luminous flux that has passed through the two split regions.

An area that is a target of focusing on the imaging surface includes a block in which a first signal detection unit group including the plurality of first signal detection units arranged at a first pitch in the row direction and a second signal detection unit group including the plurality of second signal detection units arranged at the first pitch in the row direction are each disposed in a plurality of places in the column direction. The positions of the first signal detection units in the row direction, which constitute a plurality of first signal detection unit groups, are different from each other, and the positions of the second signal detection units in the row direction, which constitute a plurality of second signal detection unit groups, are different from each other. Further, an arrangement pitch of the first signal detection units in a state where the first signal detection units, which constitute the plurality of first signal detection unit groups, are arranged in the row direction in the order of the positions is a second pitch shorter than the first pitch, and an arrangement pitch of the second signal detection units in a state where the second signal detection units, which constitute the plurality of second signal detection unit groups, are arranged in the row direction in the order of the positions is the second pitch.

The imaging device disclosed in WO2015/146228A comprises a frequency determination unit, a defocus amount generation unit, and a focus controller. The frequency determination unit determines whether a subject image formed on the area includes a frequency component equal to or higher than a first threshold value. In a case where the frequency determination unit determines that the subject image does not include the frequency component equal to or higher than the first threshold value, the defocus amount generation unit performs a first generation process of generating a defocus amount based on a correlation calculation result of detection signals of the first signal detection unit group and detection signals of the second signal detection unit group in the block. In addition, in a case where the frequency determination unit determines that the subject image includes the frequency component equal to or higher than the first threshold value, the defocus amount generation unit performs a second generation process of generating the defocus amount based on a correlation calculation result of a detection signal group in which detection signals of the first signal detection units that constitute the plurality of first signal detection unit groups in the block are arranged in the order of the positions in the row direction and a detection signal group in which detection signals of the second signal detection units that constitute the plurality of second signal detection unit groups in the block are arranged in the order of the positions in the row direction. The focus controller performs focus control of the imaging optical system based on the defocus amount generated by the first generation process or the second generation process.

### SUMMARY

One embodiment of the technology of the present disclosure provides a focus control device that can contribute to detecting an accurate focus position, an operation method of a focus control device, an operation program of a focus control device, and an imaging device.

The present disclosure relates to a focus control device comprising: a processor configured to determine a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

It is preferable that the reference pixel and the neighboring pixel are arranged on the same line, as the neighboring pixel, there are two neighboring pixels of one neighboring pixel located in a first direction of the line and one neighboring pixel located in a second direction opposite to the first direction with respect to the reference pixel, and as the difference, there are a first difference between the pixel value of the reference pixel and a pixel value of one of the two neighboring pixels, and a second difference between the pixel value of the reference pixel and a pixel value of the other of the two neighboring pixels.

It is preferable that the two neighboring pixels are located symmetrically with respect to the reference pixel.

It is preferable that the reference pixel and the two neighboring pixels are adjacent to each other.

It is preferable that, in a case where the pixel value of the reference pixel is denoted by G(K+1), the pixel value of the one of the two neighboring pixels is denoted by G(K), the pixel value of the other of the two neighboring pixels is denoted by G(K+2), K is 0 to N−2, and N is a total number of the phase-difference detection pixels related to calculation of the difference, the first difference is G(K+1)−G(K), and the second difference is G(K+2)−G(K+1).

It is preferable that the processor is configured to determine the detection method in accordance with a combination of signs of the first difference and the second difference.

It is preferable that the processor is configured to determine whether a change in the pixel values of the reference pixel and the neighboring pixel forms a peak or a valley based on the combination.

It is preferable that the processor is configured to determine the detection method in accordance with the number of the reference pixels determined to have a first index value related to the first difference and the second difference larger than a first threshold value, the first index value being determined for the reference pixel and the neighboring pixel that are determined to have the change that forms the peak or the valley.

It is preferable that the first index value is a ratio between a larger value of the first difference and the second difference and a representative value of the difference.

It is preferable that the processor is configured to determine the detection method in accordance with a second index value related to the number.

It is preferable that the second index value is a ratio of the number to a total number of the phase-difference detection pixels related to calculation of the difference.

It is preferable that the processor is configured to determine a level of a frequency component of the focus detection region based on a comparison result between the second index value and a second threshold value, and determine the detection method in accordance with a determination result of the level.

It is preferable that the processor is configured to detect the focus position in accordance with a first detection method in a case where the determination result indicates that a level of a high-frequency component of the focus detection region is relatively high, and detect the focus position in accordance with a second detection method different from the first detection method in a case where the determination result indicates that a level of a low-frequency component of the focus detection region is relatively high.

It is preferable that the processor is configured to detect the focus position in accordance with the first detection method and the second detection method in a case where the determination result indicates that a level of a medium-frequency component of the focus detection region is relatively high.

It is preferable that there are a plurality of the first detection methods, and the processor is configured to aggregate detection reference information of the plurality of first detection methods.

It is preferable that the processor is configured to determine the level for each of a plurality of split regions obtained by splitting the focus detection region, and determine the detection method for each of the plurality of split regions.

It is preferable that the processor is configured not to determine the level in a case where a set condition is satisfied.

It is preferable that the processor is configured not to determine the level in a case where a subject in the focus detection region is a set subject.

It is preferable that the set subject is a subject having a relatively high level of a high-frequency component.

It is preferable that the processor is configured not to determine the level in a case where the focus detection region smaller than a threshold size is set.

It is preferable that the pixel value of the reference pixel and the pixel value of the neighboring pixel are representative values of pixel values of the plurality of phase-difference detection pixels.

The present disclosure relates to an operation method of a focus control device, the operation method comprising: determining a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

The present disclosure relates to an operation program of a focus control device, the operation program causing a computer to execute a process comprising: determining a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

The present disclosure relates to an imaging device comprising: the focus control device described above.

### BRIEF DESCRIPTION OF THE DRAWINGS

Exemplary embodiments according to the technique of the present disclosure will be described in detail based on the following figures, wherein:

FIG. 1 is a front view of an imaging device;

FIG. 2 is a rear view of the imaging device;

FIG. 3 is a block diagram illustrating an electric configuration of the imaging device;

FIG. 4 is a diagram illustrating an arrangement of pixels of an imaging element;

FIG. 5 is a diagram illustrating a configuration of a normal pixel;

FIG. 6 is a diagram illustrating a configuration of a first phase-difference detection pixel;

FIG. 7 is a diagram illustrating a configuration of a second phase-difference detection pixel;

FIG. 8 is a graph illustrating a phase difference between a first calculation signal and a second calculation signal;

FIG. 9 is a diagram illustrating a focus detection region;

FIGS. 10A and 10B are diagrams illustrating calculation data, in which FIG. 10A illustrates first calculation data and FIG. 10B illustrates second calculation data;

FIG. 11 is a block diagram illustrating a detailed configuration of a controller;

FIG. 12 is a block diagram illustrating a detailed configuration of a focus controller;

FIG. 13 is a block diagram illustrating a detailed configuration of a determination unit;

FIG. 14 is a diagram illustrating processing of a representative value calculation unit;

FIGS. 15A to 15C are diagrams illustrating processing of a difference calculation unit;

FIG. 16 is a graph visualizing a relationship between a pixel value of a reference pixel, a pixel value of a first neighboring pixel, and a pixel value of a second neighboring pixel and a first difference and a second difference;

FIG. 17 is a diagram illustrating a difference calculation result;

FIGS. 18A and 18B are diagrams illustrating processing of a change type determination unit, in which FIG. 18A illustrates a case where a change of the pixel values of the reference pixel and the neighboring pixel forms a peak, and FIG. 18B illustrates a case where the change forms a valley;

FIG. 19 is a diagram illustrating a change type determination result;

FIG. 20 is a diagram illustrating processing of calculating a first index value by a first comparison/counting unit;

FIG. 21 is a diagram illustrating processing of the first comparison/counting unit and a second comparison unit;

FIG. 22 is a diagram illustrating a relationship between a second_1 threshold value, a second_2 threshold value, and content of a determination result;

FIG. 23 is a diagram illustrating processing of a detection unit;

FIG. 24 is a diagram illustrating a first_1 detection method;

FIG. 25 is a diagram illustrating a first_2 detection method;

FIG. 26 is a diagram illustrating a first_3 detection method;

FIG. 27 is a diagram illustrating a second detection method;

FIGS. 28A to 28C are diagrams illustrating processing of determining the detection method in accordance with the determination result, in which FIG. 28A illustrates a case where it is determined that a level of a low-frequency component is relatively high, FIG. 28B illustrates a case where it is determined that a level of a medium-frequency component is relatively high, and FIG. 28C illustrates a case where it is determined that a level of a high-frequency component is relatively high;

FIG. 29 is a diagram illustrating processing of adding and averaging correlation curves obtained by a plurality of first detection methods to aggregate the correlation curves;

FIG. 30 is a flowchart illustrating a processing procedure of the focus controller;

FIG. 31 is a diagram illustrating a second embodiment in which the focus detection region is split into a plurality of split regions;

FIG. 32 is a diagram illustrating processing of a third_1 embodiment; and

FIG. 33 is a diagram illustrating processing of a third_2 embodiment.

### DETAILED DESCRIPTION

### First Embodiment

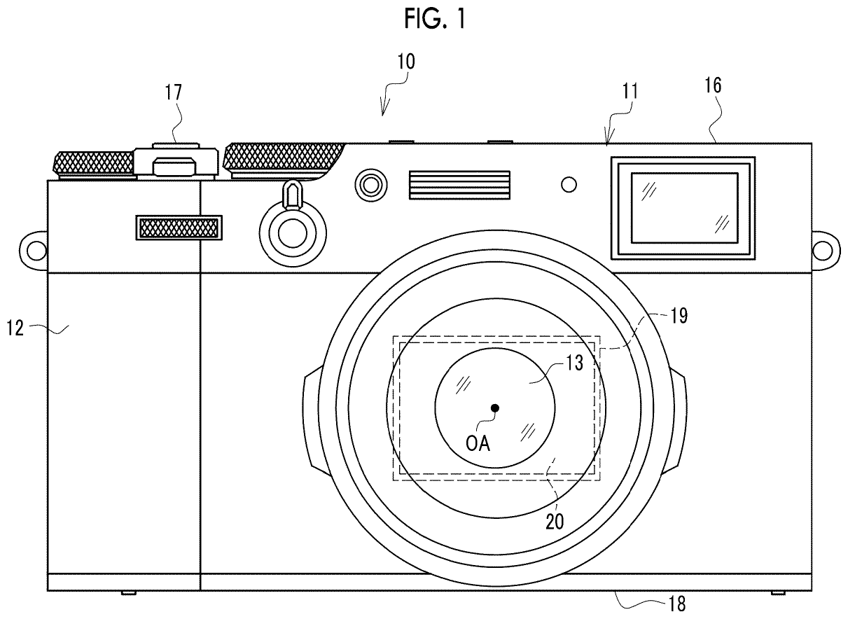

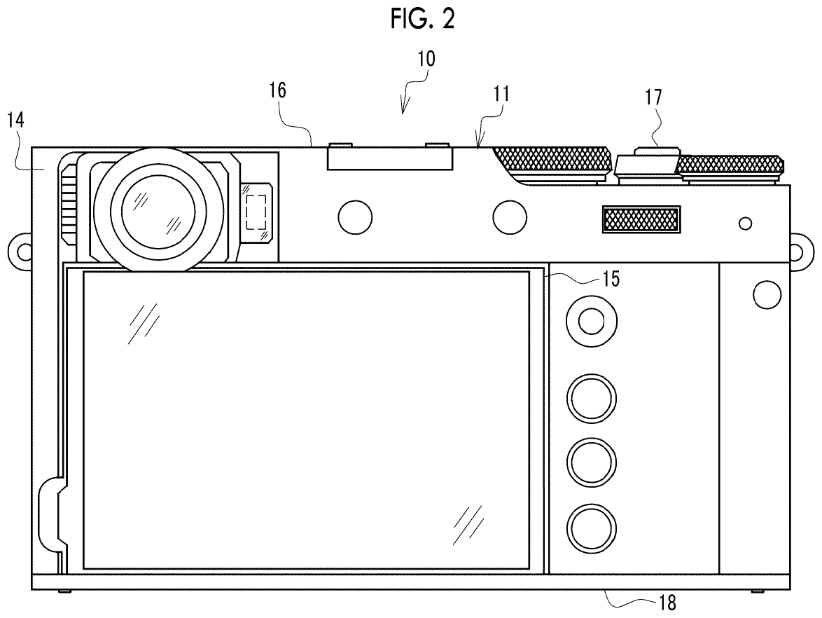

As illustrated in FIGS. 1 and 2 as an example, an imaging device 10 is, for example, a digital camera, and comprises a device body 11. An imaging lens 13 and the like are disposed on a front surface 12 of the device body 11. In addition, a liquid crystal monitor 15 and the like are disposed on a rear surface 14 of the device body 11 opposite to the front surface 12. Various operation members such as a power switch-integrated release button (hereinafter, simply referred to as a release button) 17 are disposed on a top surface 16 of the device body 11 connecting the front surface 12 and the rear surface 14. A tripod screw hole (not illustrated) and the like are disposed on a bottom surface 18 of the device body 11, which is the other surface connecting the front surface 12 and the rear surface 14. In addition, the imaging device 10 may be a lens-interchangeable camera in which the imaging lens 13 is interchangeable.

An imaging element 19 is disposed behind the imaging lens 13. The imaging element 19 is, for example, a complementary metal-oxide-semiconductor (CMOS) image sensor or a charge coupled device (CCD) image sensor. The imaging element 19 has an imaging surface 20 on which subject light is formed. The imaging element 19 is disposed such that the center of the imaging surface 20 matches an optical axis OA of the imaging lens 13 and the imaging surface 20 becomes orthogonal to the optical axis OA. The terms “match” and “orthogonal” as used herein mean not only perfect match and orthogonality but also match and orthogonality in a sense including an error generally allowed in the technical field to which the technology of the present disclosure belongs.

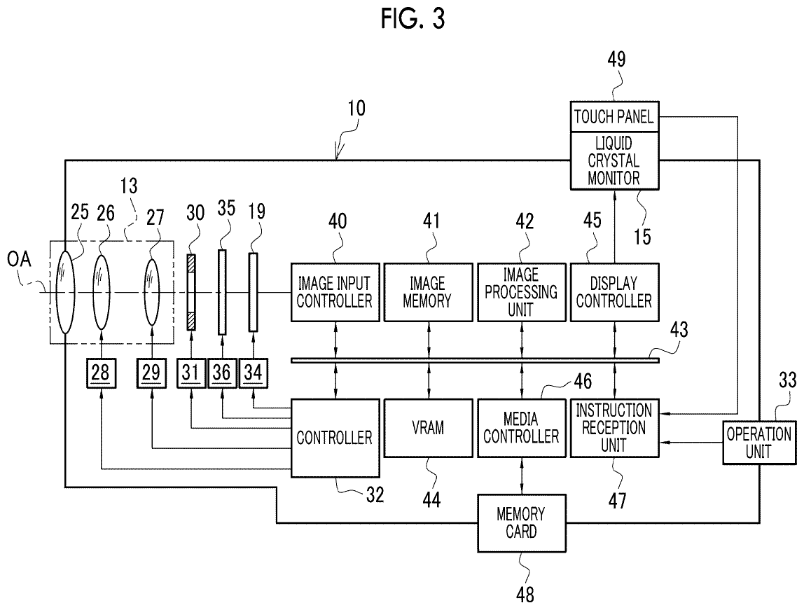

As illustrated in FIG. 3 as an example, the imaging lens 13 has a plurality of types of lenses for forming a subject image on the imaging element 19. Specifically, the imaging lens 13 includes an objective lens 25, a focus lens 26, and a zoom lens 27. These respective lenses 25 to 27 are arranged in this order from an object side (subject side) to an image-forming side (imaging element 19 side). Although illustrated in FIG. 3 in a simplified manner, each of the lenses 25 to 27 is actually a lens group in which a plurality of lenses are combined.

A focus lens drive mechanism 28 is connected to the focus lens 26, and a zoom lens drive mechanism 29 is connected to the zoom lens 27. The focus lens drive mechanism 28 includes a focus cam ring that holds the focus lens 26 and that has a cam groove formed on its outer periphery, a focus motor that rotates the focus cam ring about the optical axis OA to move the focus cam ring along the optical axis OA, a driver of the focus motor, and the like. Similarly, the zoom lens drive mechanism 29 includes a zoom cam ring that holds the zoom lens 27 and that has a cam groove formed on its outer periphery, a zoom motor that rotates the zoom cam ring about the optical axis OA to move the zoom cam ring along the optical axis OA, a driver of the zoom motor, and the like.

A stop 30 is disposed on the image-forming side of the imaging lens 13. The stop 30 is, for example, an iris stop and is formed by a combination of a plurality of stop leaf blades. The stop 30 adjusts an amount of light passing therethrough by simultaneously moving the stop leaf blades using a cam mechanism to open and close a central aperture formed by inner edges of the stop leaf blades, that is, by changing an opening of the aperture. A stop opening adjustment mechanism 31 is connected to the stop 30. The stop opening adjustment mechanism 31 includes a stop motor that opens and closes the stop leaf blades, a driver for the stop motor, and the like.

For example, various motors such as the focus motor, the zoom motor, and the stop motor are stepping motors. In this case, the position of the focus lens 26 and the position of the zoom lens 27 on the optical axis OA and the opening of the stop 30 can be derived from drive amounts of the focus motor, the zoom motor, and the stop motor. Instead of using the drive amounts of the focus motor and the zoom motor, a position sensor may be provided to detect the position of the focus lens 26 and the position of the zoom lens 27.

Electrical components such as the motor (focus motor, zoom motor, and stop motor) or the driver of each of the drive mechanisms 28, 29, and 31 are connected to a controller 32. The electrical components of the drive mechanisms 28, 29, and 31 are driven under the control of the controller 32. More specifically, the controller 32 issues a drive signal in response to an instruction from a user, which is input via an operation unit 33, to drive the electrical components of each of the drive mechanisms 28, 29, and 31. For example, in a case where an instruction to change an angle of view to a telephoto side is input via an angle-of-view change switch included in the operation unit 33, the controller 32 outputs a drive signal to the driver for the zoom motor of the zoom lens drive mechanism 29 to move the zoom lens 27 to the telephoto side.

The operation unit 33 is a general term for members operated by the user, such as a menu button and a cross key, in addition to the release button 17. Here, the release button 17 is a two-stage push button that can be operated by being halfway pressed and fully pressed. An imaging preparation instruction to prepare for capturing a still image or a moving image is issued by the halfway-press operation on the release button 17, and an imaging start instruction to start capturing the still image or the moving image is issued by the full-press operation of the release button 17.

The operation unit 33 also includes a mode selector switch for switching operation modes of the imaging device 10. The operation modes include a still image capturing mode, a moving image capturing mode, an image playback mode, a setting mode, and the like. The still image capturing mode includes not only a normal imaging mode in which one still image is captured but also a continuous imaging mode in which the still images are continuously captured at a predetermined imaging interval, for example, a frame rate of 5 frames per second (fps) to 10 fps. The continuous imaging mode is started up, for example, in a case where a fully-press state of the release button 17 is continued for a predetermined time or longer. The continuous imaging mode ends in a case where the fully-press state of the release button 17 is released.

The drive amounts of the focus motor, the zoom motor, and the stop motor are output to the controller 32. The controller 32 derives the positions of the focus lens 26 and the zoom lens 27 on the optical axis OA and the opening of the stop 30 from the drive amounts.

An imaging element driver 34 is connected to the imaging element 19. The imaging element driver 34 is connected to the controller 32. Under the control of the controller 32, the imaging element driver 34 controls a timing when the subject image is captured by the imaging element 19 by supplying a vertical scanning signal and a horizontal scanning signal to the imaging element 19.

A shutter 35 is disposed between the imaging lens 13 and the imaging element 19. The shutter 35 is, for example, a focal plane shutter having a front curtain and a rear curtain. A shutter drive mechanism 36 is connected to the shutter 35. The shutter drive mechanism 36 includes an electromagnet, a motor, a charge lever, a driver, and the like that hold the front curtain and the rear curtain and release the holding to cause the front curtain and the rear curtain to run. The shutter drive mechanism 36 is driven under the control of the controller 32 to open and close the shutter 35.

The controller 32 is connected to respective units such as an image input controller 40, an image memory 41, and an image processing unit 42 through a busline 43. Further, a video random-access memory (VRAM) 44, a display controller 45, a media controller 46, an instruction reception unit 47, and the like are connected to the busline 43. Although not illustrated, a strobe drive controller that controls the drive of a strobe device, an external communication interface (I/F) that communicates with an external device via a connection terminal such as a universal serial bus (USB) terminal, a wireless communication I/F that communicates with an external device via a wireless antenna, or the like is also connected to the busline 43.

Image data obtained by imaging the subject light is input to the image input controller 40 from the imaging element 19. The image input controller 40 outputs the image data to the image memory 41. The image memory 41 is, for example, a synchronous dynamic random-access memory (SDRAM) and temporarily stores the image data.

The image processing unit 42 reads out the unprocessed image data from the image memory 41. The image processing unit 42 performs various types of image processing on the image data. The various types of image processing include, for example, offset correction processing, sensitivity correction processing, pixel interpolation processing, white balance correction processing, gamma correction processing, demosaicing, generation processing of a brightness signal and a color difference signal, contour enhancement processing, and color correction processing. The image processing unit 42 writes the image data that has been subjected to the various types of image processing back to the image memory 41.

The image data that has been subjected to the various types of image processing and is to be displayed as a live view image is input to the VRAM 44 from the image memory 41. The VRAM 44 has a region for storing the image data for two consecutive frames. The image data stored in the VRAM 44 is sequentially rewritten with the new image data. The VRAM 44 sequentially outputs newer image data of the image data for the two consecutive frames to the display controller 45.

The display controller 45 functions as a so-called video encoder that converts the image data from the VRAM 44 into video data and outputs the video data to the liquid crystal monitor 15. Accordingly, the user can visually recognize the live view image through the liquid crystal monitor 15. The display frame rate of the live view image is, for example, 60 fps.

In a case where an imaging start instruction to start capturing the still image or the moving image is issued by the full-press operation of the release button 17, the image processing unit 42 performs compression processing on the image data in the image memory 41. In a case of the still image, for example, the image processing unit 42 performs compression processing of a joint photographic experts group (JPEG) format on the image data.

In a case of the moving image, for example, the image processing unit 42 performs compression processing of a moving picture experts group (MPEG) format on the image data. The image processing unit 42 outputs the image data that has been subjected to the compression processing to the media controller 46.

The media controller 46 records the image data that has been subjected to the compression processing from the image processing unit 42 on a memory card 48. The memory card 48 is attachably and detachably mounted in a memory card slot (not illustrated).

In a case where the image playback mode is selected via the mode selector switch of the operation unit 33, the media controller 46 reads out the image data from the memory card 48 to output the read-out image data to the image processing unit 42. The image processing unit 42 performs decompression processing on the image data from the memory card 48. The image data that has been subjected to the decompression processing is output to the display controller 45. The display controller 45 converts the image data into the video data and outputs the video data to the liquid crystal monitor 15. Therefore, the user can visually recognize a playback image through the liquid crystal monitor 15.

The instruction reception unit 47 receives various operation instructions input by the user via the operation unit 33 and a touch panel 49 integrally provided with the liquid crystal monitor 15. The instruction reception unit 47 outputs the received various operation instructions to the controller 32 via the busline 43. The touch panel 49 is superimposed on the display surface of the liquid crystal monitor 15. The touch panel 49 detects contact with a finger of the user or a dedicated indicator such as a stylus pen, thereby recognizing the various operation instructions by the user.

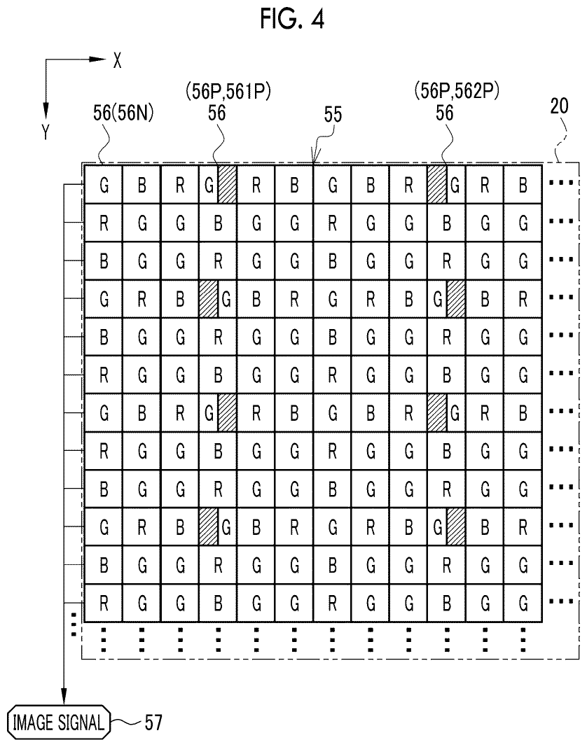

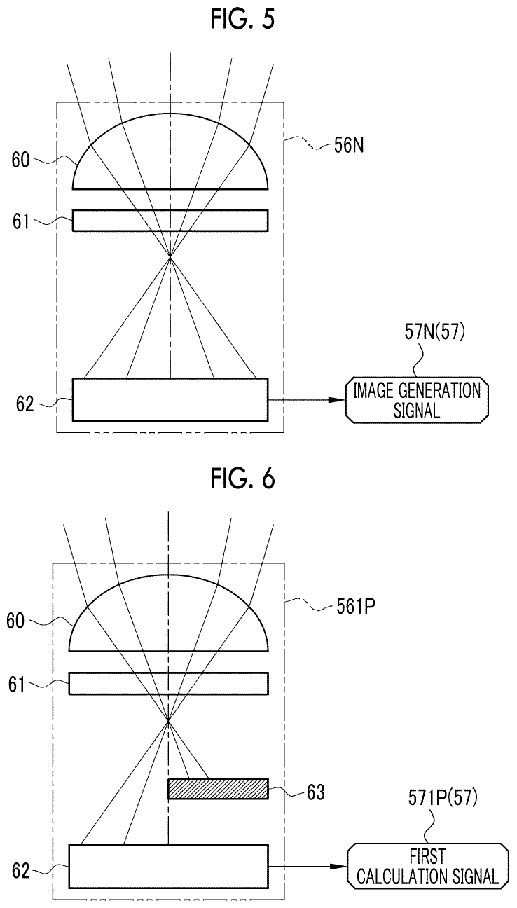

As illustrated in FIG. 4 as an example, the imaging element 19 is provided with a photoelectric conversion unit 55. The photoelectric conversion unit 55 is composed of a plurality of pixels 56 that are two-dimensionally arranged along an X direction and a Y direction. The plurality of pixels 56 form the imaging surface 20. As is well known, the pixel 56 is composed of a microlens 60, a color filter 61, and a photoelectric conversion element 62 such as the photodiode (see FIGS. 5 to 7). The X direction and the Y direction are a horizontal direction and a vertical direction in a state where the bottom surface 18 of the imaging device 10 is placed on the horizontal plane.

Scanning lines parallel to the X direction are wired between the rows of the pixels 56. In addition, signal lines parallel to the Y direction are wired between the columns of the pixels 56. The pixels 56 (photoelectric conversion elements 62 thereof) are connected to the signal lines via an amplifier and a switch. The scanning line is also connected to the switch. In a case of an accumulation operation in which the signal charges corresponding to the subject light are accumulated in the pixels 56 (photoelectric conversion elements 62 thereof), an OFF signal is supplied as a vertical scanning signal through the scanning line to turn off the switch. In a case of a readout operation in which image signals (voltage signals) 57 corresponding to the signal charges are read out from the pixels 56 (photoelectric conversion elements 62 thereof), an ON signal is supplied as a vertical scanning signal through the scanning line to turn on the switch. Terminals of the signal line are connected to a correlated double sampling (CDS) circuit and an analog-to-digital converter (ADC) circuit. The CDS circuit performs correlated double sampling on the image signal 57 input through the signal line. The ADC circuit converts the image signal 57 after the correlated double sampling into the digital image signal 57.

The pixels 56 are split, depending on a type of the color filter 61, into three types of a green pixel (referred to as “G” in FIG. 4) having sensitivity to light in a green wavelength range, a red pixel (referred to as “R” in FIG. 4) having sensitivity to light in a red wavelength range, and a blue pixel (referred to as “B” in FIG. 4) having sensitivity to light in a blue wavelength range. The three types of the pixels 56 are regularly arranged in a predetermined arrangement. As the predetermined arrangement, a so-called Bayer array is described here, in which two green pixels, one blue pixel, and one red pixel are arranged in vertical and horizontal 2×2 pixels.

A normal pixel 56N and a phase-difference detection pixel 56P are included in the pixels 56. A first phase-difference detection pixel 561P and a second phase-difference detection pixel 562P are further included in the phase-difference detection pixels 56P. The normal pixels 56N are of three types, that is, a green pixel, a blue pixel, and a red pixel, but the phase-difference detection pixels 56P are only green pixels.

The phase-difference detection pixels 56P are arranged at predetermined intervals in the X direction and the Y direction. In FIG. 4, the phase-difference detection pixels 56P are arranged at intervals of five pixels in the X direction and at intervals of two pixels in the Y direction. In addition, as the phase-difference detection pixels 56P, the first phase-difference detection pixel 561P and the second phase-difference detection pixel 562P are arranged alternately in the X direction and the Y direction. For example, in a case of the fourth row, the phase-difference detection pixels 56P are arranged, from left to right, in an order of the second phase-difference detection pixel 562P, the first phase-difference detection pixel 561P, and the like. In addition, for example, in a case of the tenth column, the phase-difference detection pixels 56P are arranged, from top to bottom, in an order of the second phase-difference detection pixel 562P, the first phase-difference detection pixel 561P, the second phase-difference detection pixel 562P, the first phase-difference detection pixel 561P, and the like.

The first phase-difference detection pixel 561P and the second phase-difference detection pixel 562P adjacent in the X direction and the Y direction constitute one set for detecting a phase difference α (see FIG. 8).

As illustrated in FIGS. 5 to 7 as an example, the normal pixel 56N, the first phase-difference detection pixel 561P, and the second phase-difference detection pixel 562P have the same basic configuration. That is, the normal pixel 56N, the first phase-difference detection pixel 561P, and the second phase-difference detection pixel 562P are each composed of the microlens 60, the color filter 61, and the photoelectric conversion element 62 that are arranged in order from the object side.

As illustrated in FIG. 5, the photoelectric conversion element 62 of the normal pixel 56N outputs, as the image signal 57, an image generation signal 57N corresponding to the subject light condensed by the microlens 60 and transmitted through the color filter 61. The image generation signal 57N is stored in the image memory 41 as a portion of the image data.

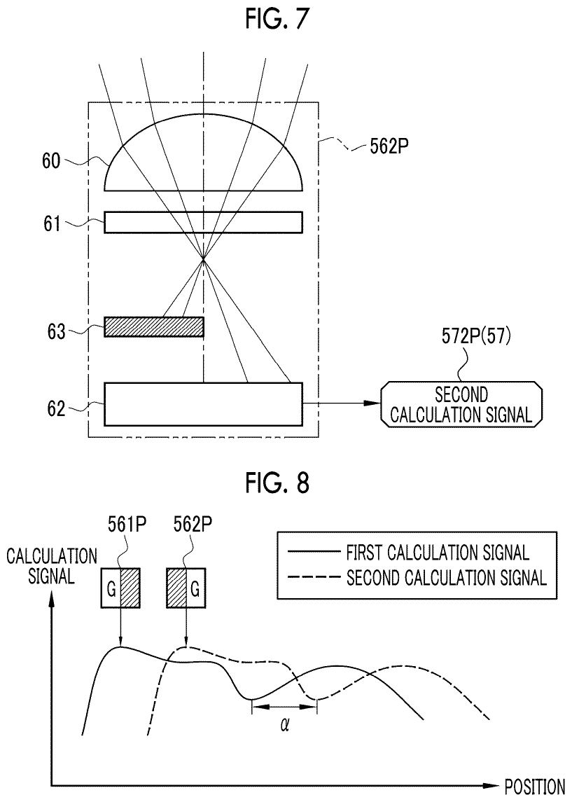

As illustrated in FIGS. 6 and 7, a light shielding member 63 is disposed between the color filter 61 and the photoelectric conversion element 62 of the first phase-difference detection pixel 561P and the second phase-difference detection pixel 562P. This light shielding member 63 is not disposed in the normal pixel 56N. The light shielding member 63 of the first phase-difference detection pixel 561P shields a right half of the photoelectric conversion element 62 as viewed from the object side. With respect to this, the light shielding member 63 of the second phase-difference detection pixel 562P shields a left half of the photoelectric conversion element 62 as viewed from the object side.

The photoelectric conversion element 62 of the first phase-difference detection pixel 561P outputs, as the image signal 57, a first calculation signal 571P corresponding to the subject light condensed by the microlens 60, transmitted through the color filter 61, and having the right half shielded by the light shielding member 63. With respect to this, the photoelectric conversion element 62 of the second phase-difference detection pixel 562P outputs, as the image signal 57, a second calculation signal 572P corresponding to the subject light condensed by the microlens 60, transmitted through the color filter 61, and having the left half shielded by the light shielding member 63. The first calculation signal 571P and the second calculation signal 572P are stored in the image memory 41 as a portion of the image data, as with the image generation signal 57N. In the following description, unless there is a particular need to distinguish between the first calculation signal 571P and the second calculation signal 572P, the first calculation signal 571P and the second calculation signal 572P will be collectively referred to as a calculation signal 57P.

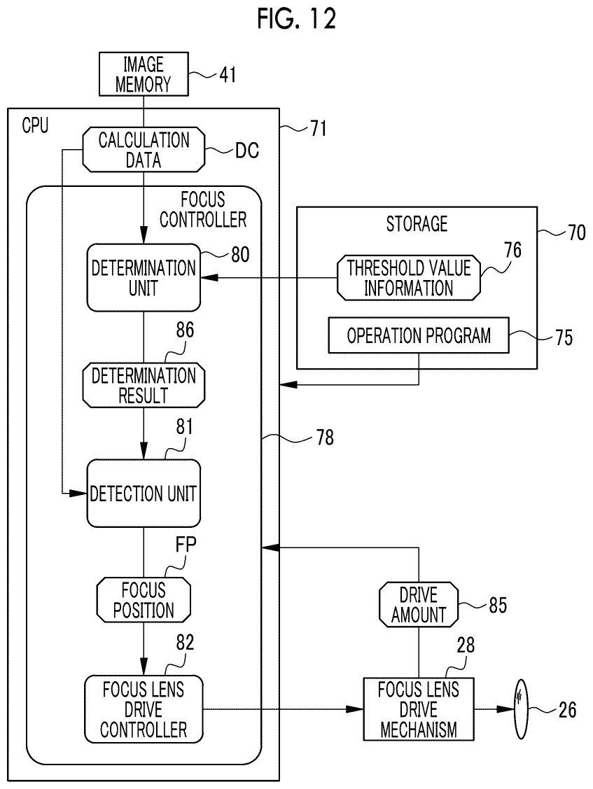

As illustrated in FIG. 8 as an example, the phase difference α appears between the first calculation signal 571P and the second calculation signal 572P, which are output from the first phase-difference detection pixel 561P and the second phase-difference detection pixel 562P adjacent in the X direction and the Y direction. The phase difference α is also referred to as parallax. The phase difference α indicates how much and in which direction the focus lens 26 should be moved to reach a focus position FP (see FIG. 12). The controller 32 detects the focus position FP of the focus lens 26 based on the phase difference α, and performs autofocus control of automatically moving the focus lens 26 to the focus position FP.

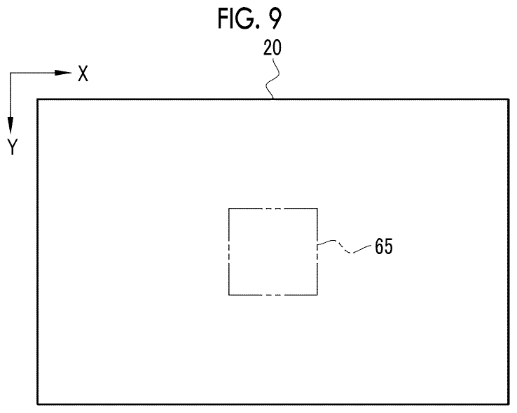

As illustrated in FIG. 9 as an example, a focus detection region 65 for detecting the focus position FP is preset at the center portion of the imaging surface 20. The focus detection region 65 may be a region designated by the user, or a region surrounding a specific subject recognized by a known subject recognition technique. The specific subject is a pupil, a face, or a body of a person; a pupil, a face, or a body of an animal; or a head, a body, or the like of a vehicle such as an automobile, a railway vehicle, or an airplane. Here, the pupil of the person or the animal means a pupil that is a so-called black eye. The face of the person or the animal means a portion having, for example, a forehead, a cheek, a chin, eyes, a nose, a mouth, and ears. The body of the person or the animal means a portion excluding a head, a neck, limbs, and a tail. The head of the vehicle means a front body in a case of the automobile, a portion of a head car having a destination display, a front window, a headlight, or the like in a case of the railway car, and a nose portion having a radome, front window, or the like in a case of the airplane. The body of the vehicle means the entire body excluding wheels in a case of the automobile, the entire body excluding wheels in a case of the railway car regardless of whether the car is a head car, an intermediate car, or a last car, and the entire body excluding a head, main wings, a tail, and the like in a case of the airplane. In addition, the focus detection region 65 may be the entire imaging surface 20.

The image generation signal 57N is used for generating the captured image such as the live view image as its name indicates. On the other hand, the calculation signal 57P is used only to detect the phase difference α and the focus position FP and is not used to generate the captured image. Therefore, in the pixel interpolation processing, the image processing unit 42 interpolates a pixel value of the phase-difference detection pixel 56P using the image generation signals 57N of the normal pixels 56N around the phase-difference detection pixel 56P.

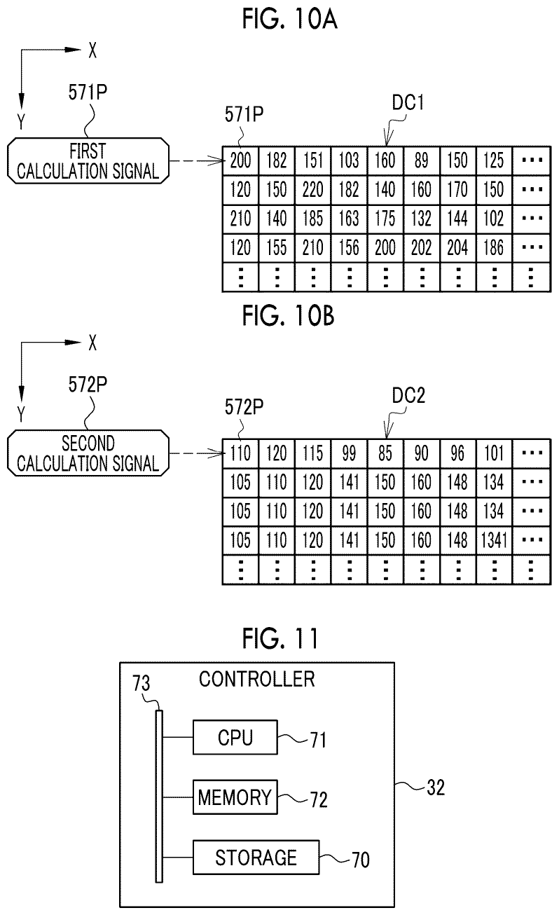

Here, specifically, the calculation signal 57P is split into, for example, first calculation data DC1 illustrated in FIG. 10A and second calculation data DC2 illustrated in FIG. 10B. The first calculation data DC1 is data in which a plurality of first calculation signals 571P output from the first phase-difference detection pixel 561P are two-dimensionally arranged in the X direction and the Y direction according to the arrangement of the first phase-difference detection pixels 561P. The second calculation data DC2 is data in which a plurality of second calculation signals 572P output from the second phase-difference detection pixel 562P are two-dimensionally arranged in the X direction and the Y direction according to the arrangement of the second phase-difference detection pixels 562P. The first calculation data DC1 and the second calculation data DC2 can be regarded as two-dimensional image data. In the following description, unless there is a particular need to distinguish between the first calculation data DC1 and the second calculation data DC2, the first calculation data DC1 and the second calculation data DC2 will be collectively referred to as calculation data DC.

As illustrated in FIG. 11 as an example, the controller 32 comprises a storage 70, a central processing unit (CPU) 71, and a memory 72. The storage 70, the CPU 71, and the memory 72 are connected to each other via a busline 73. The controller 32 is an example of a “focus control device” and a “computer” of the technology of the present disclosure.

For example, the storage 70 is a non-volatile storage device such as an electrically erasable programmable read-only memory (EEPROM). Various programs, various data associated with the various programs, and the like are stored in the storage 70. In addition, instead of the EEPROM, a ferroelectric random-access memory (FeRAM) or a magnetoresistive random-access memory (MRAM) may be used as the storage 70.

The memory 72 is a work memory for the CPU 71 to execute processing. The CPU 71 loads the program stored in the storage 70 into the memory 72, and executes processing corresponding to the loaded program. Therefore, the CPU 71 comprehensively controls the respective units of the imaging device 10. The CPU 71 is an example of a “processor” of the technology of the present disclosure. In addition, the memory 72 may be built in the CPU 71.

As illustrated in FIG. 12 as an example, an operation program 75 is stored in the storage 70. The operation program 75 is a program causing the CPU 71 to perform the autofocus control or the like. That is, the operation program 75 is an example of an “operation program of a focus control device” of the technology of the present disclosure. Threshold value information 76 is also stored in the storage 70.

In a case where the operation program 75 is started up, the CPU 71 functions as a focus controller 78 in cooperation with the memory 72 and the like. The focus controller 78 includes a determination unit 80, a detection unit 81, and a focus lens drive controller 82. In addition, the CPU 71 also functions as various processing units in addition to the focus controller 78.

The focus controller 78 receives the drive amount 85 of the focus motor from the focus lens drive mechanism 28. The focus controller 78 derives a current position of the focus lens 26 from the drive amount 85.

The determination unit 80 reads out the calculation data DC from the image memory 41. Further, the determination unit 80 reads out the threshold value information 76 from the storage 70. The determination unit 80 determines a level of a frequency component of the focus detection region 65 based on the calculation data DC and the threshold value information 76. The determination unit 80 outputs a determination result 86 of the level to the detection unit 81.

The calculation data DC is also input to the detection unit 81. The detection unit 81 detects the phase difference α illustrated in FIG. 8 by a detection method corresponding to the determination result 86 of the level, and detects the focus position FP based on the phase difference α. The detection unit 81 outputs the focus position FP to the focus lens drive controller 82.

The focus lens drive controller 82 controls the drive of the focus lens drive mechanism 28 and the focus lens 26. Specifically, the focus lens drive controller 82 moves the focus lens 26 from the current position to the focus position FP detected by the detection unit 81 via the focus lens drive mechanism 28. Here, the phrase “The focus lens drive controller 82 moves the focus lens 26” strictly means that the focus lens drive controller 82 issues the drive signal to the driver of the focus motor of the focus lens drive mechanism 28, causing the focus motor to move the focus lens 26. In a case where the current position of the focus lens 26 matches the focus position FP or a difference between the current position and the focus position FP is within an allowable range, the focus lens drive controller 82 does not perform any processing, and thus the focus lens 26 is not moved.

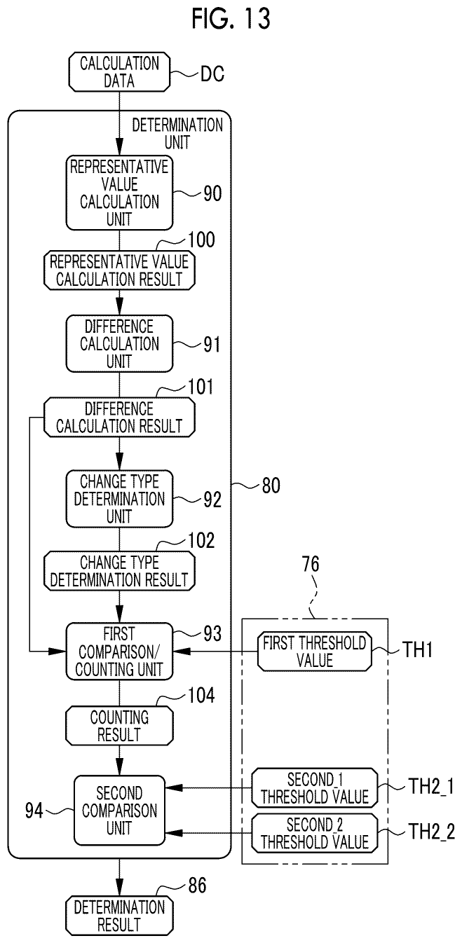

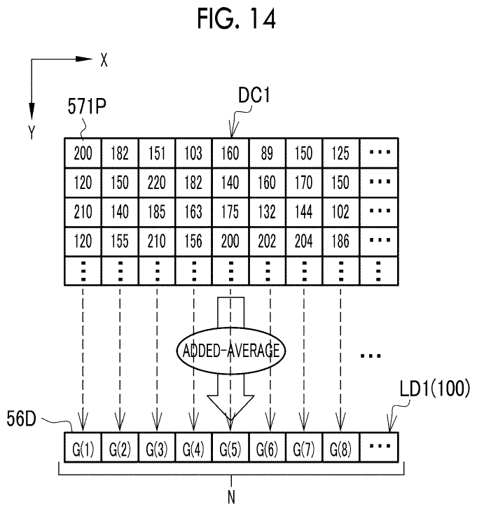

As illustrated in FIG. 13 as an example, the determination unit 80 functions as a representative value calculation unit 90, a difference calculation unit 91, a change type determination unit 92, a first comparison/counting unit 93, and a second comparison unit 94. The calculation data DC is input to the representative value calculation unit 90. As illustrated in FIG. 14 as an example, the representative value calculation unit 90 calculates, for example, an addition-averaged value of a plurality of first calculation signals 571P arranged in the Y direction for each column of the first calculation data DC1 as the representative value of the first calculation signal 571P. The representative value calculation unit 90 outputs the first line data LD1, which is a set of the addition-averaged values of each column obtained in this manner, to the difference calculation unit 91 as a representative value calculation result 100. In a case where the number of columns of the first calculation data DC1 is N, the number of addition-averaged values of the first line data LD1 is also N. The first line data LD1 can be regarded as one-dimensional image data. Hereinafter, a unit component of the first line data LD1 having one addition-averaged value is referred to as a difference calculation pixel 56D. The difference calculation pixel 56D is an example of a “phase-difference detection pixel related to calculation of the difference” of the technology of the present disclosure. In addition, each addition-averaged value of the first line data LD1 is referred to as a difference calculation pixel values G(1), G(2), and the like. The addition-averaged value is an example of a “representative value of pixel values of the plurality of phase-difference detection pixels” of the technology of the present disclosure. The “representative value of pixel values of the plurality of phase-difference detection pixels” may be a mode value, a median value, or the like of the plurality of first calculation signals 571P arranged in the Y direction instead of the addition-averaged value.

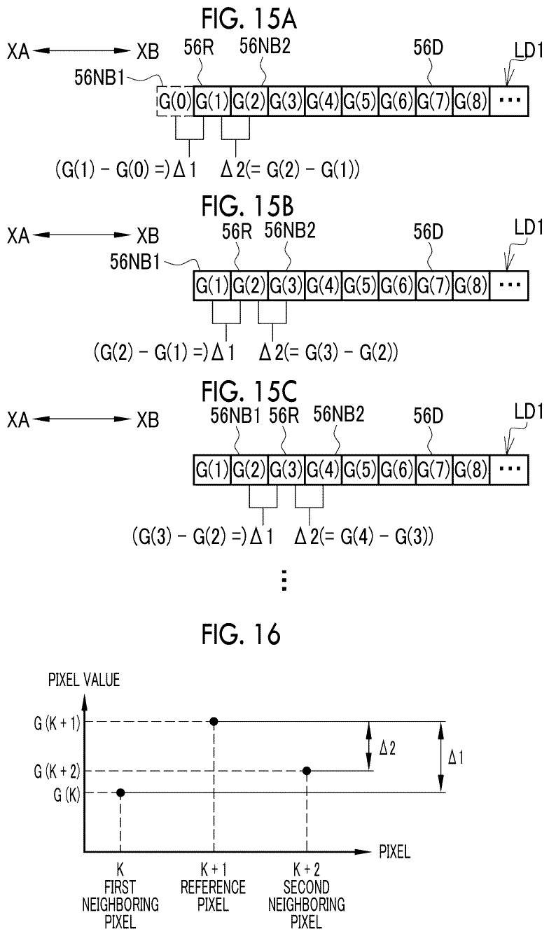

As illustrated in FIGS. 15A to 15C as an example, the difference calculation unit 91 calculates a first difference Δ1 between a pixel value G(K+1) (K is 0 to N−2) of a reference pixel 56R among the difference calculation pixels 56D arranged in an XA direction (left direction) and an XB direction (right direction) that are parallel to the X direction and a pixel value G(K) of a first neighboring pixel 56NB1 present in one pixel with respect to the reference pixel 56R, and a second difference Δ2 between the pixel value G(K+1) of the reference pixel 56R and a pixel value G(K+2) of a second neighboring pixel 56NB2. Hereinafter, in a case where there is no need to particularly distinguish between the first neighboring pixel 56NB1 and the second neighboring pixel 56NB2, the first neighboring pixel 56NB1 and the second neighboring pixel 56NB2 are collectively referred to as a neighboring pixel 56NB. Similarly, the first difference Δ1 and the second difference Δ2 are collectively referred to as a difference Δ. The XA direction is an example of a “first direction” of the technology of the present disclosure. The XB direction is an example of a “second direction” of the technology of the present disclosure. The expression “in one pixel” is an example of “in a neighboring range” of the technology of the present disclosure. The first neighboring pixel 56NB1 is an example of “one of the two neighboring pixels” of the technology of the present disclosure. The second neighboring pixel 56NB2 is an example of “the other of the two neighboring pixels” of the technology of the present disclosure.

First, as illustrated in FIG. 15A, the difference calculation unit 91 sets a first difference calculation pixel 56D at a left end of the first line data LD1 as the reference pixel 56R, a zeroth difference calculation pixel 56D adjacent to the left of the first difference calculation pixel 56D as the first neighboring pixel 56NB1, and a second difference calculation pixel 56D adjacent to the right of the first difference calculation pixel 56D as the second neighboring pixel 56NB2. The difference calculation unit 91 calculates a first difference Δ1 (=G(1)−G(0)) between the difference calculation pixel value G(1) of the first difference calculation pixel 56D and the difference calculation pixel value G(0) of the zeroth difference calculation pixel 56D. Further, the difference calculation unit 91 calculates a second difference Δ2 (=G(2)−G(1)) between the difference calculation pixel value G(2) of the second difference calculation pixel 56D and the difference calculation pixel value G(1) of the first difference calculation pixel 56D. The zeroth difference calculation pixel 56D does not physically exist, and is a pixel that is virtually provided to calculate the first difference Δ1. The pixel value G(0) of the zeroth difference calculation pixel 56D is, for example, a representative value such as an average value of the difference calculation pixel values G(1), G(2), and the like.

Next, as illustrated in FIG. 15B, the difference calculation unit 91 sets a second difference calculation pixel 56D as the reference pixel 56R, a first difference calculation pixel 56D adjacent to the left of the second difference calculation pixel 56D as the first neighboring pixel 56NB1, and a third difference calculation pixel 56D adjacent to the right of the second difference calculation pixel 56D as the second neighboring pixel 56NB2. The difference calculation unit 91 calculates a second difference Δ2 (=G(3)−G(2)) between the difference calculation pixel value G(3) of the third difference calculation pixel 56D and the difference calculation pixel value G(2) of the second difference calculation pixel 56D. The first difference Δ1 (=G(2)−G(1)) between the pixel value G(2) of the second difference calculation pixel 56D and the pixel value G(1) of the first difference calculation pixel 56D has already been calculated as the second difference Δ2 in FIG. 15A, and thus the result is reused.

Further, as illustrated in FIG. 15C, the difference calculation unit 91 sets a third difference calculation pixel 56D as the reference pixel 56R, a second difference calculation pixel 56D adjacent to the left of the third difference calculation pixel 56D as the first neighboring pixel 56NB1, and a fourth difference calculation pixel 56D adjacent to the right of the third difference calculation pixel 56D as the second neighboring pixel 56NB2. The difference calculation unit 91 calculates a second difference Δ2 (=G(4)−G(3)) between the difference calculation pixel value G(4) of the fourth difference calculation pixel 56D and the difference calculation pixel value G(3) of the third difference calculation pixel 56D. The first difference Δ1 (=G(3)−G(2)) between the pixel value G(3) of the third difference calculation pixel 56D and the pixel value G(2) of the second difference calculation pixel 56D has already been calculated as the second difference Δ2 in FIG. 15B, and thus the result is reused. The difference calculation unit 91 calculates the first difference Δ1 and the second difference Δ2 of the pixel values of the plurality of difference calculation pixels 56D by repeating this processing up to an (N−1)th difference calculation pixel 56D of the first line data LD1.

From the description of FIGS. 15A to 15C, the following can be understood. That is, the reference pixel 56R and the neighboring pixel 56NB are arranged on the same line. As the neighboring pixel 56NB, there are two neighboring pixels 56NB of one neighboring pixel located in the XA direction of the line and one neighboring pixel located in the XB direction opposite to the XA direction with respect to the reference pixel 56R. The difference Δ includes the first difference Δ1 between the pixel value G(K+1) of the reference pixel 56R and the pixel value G(K) of the first neighboring pixel 56NB1, and the second difference Δ2 between the pixel value G(K+1) of the reference pixel 56R and the pixel value G(K+2) of the second neighboring pixel 56NB2. The first neighboring pixel 56NB1 and the second neighboring pixel 56NB2 are located symmetrically with respect to the reference pixel 56R. Further, the reference pixel 56R, the first neighboring pixel 56NB1, and the second neighboring pixel 56NB2 are adjacent to each other.

The first difference Δ1 is represented by the following expression (1).

$$Δ 1 = G ( K + 1 ) - G ( K ) \qquad ( 1 )$$

In addition, the second difference Δ2 is represented by the following expression (2).

$$Δ 2 = G ( K + 2 ) - G ( K + 1 ) \qquad ( 2 )$$

As an example, a graph illustrated in FIG. 16 visualizes a relationship between the pixel value G(K+1) of the reference pixel 56R, the pixel value G(K) of the first neighboring pixel 56NB1, and the pixel value G(K+2) of the second neighboring pixel 56NB2 and the first difference Δ1 and the second difference Δ2.

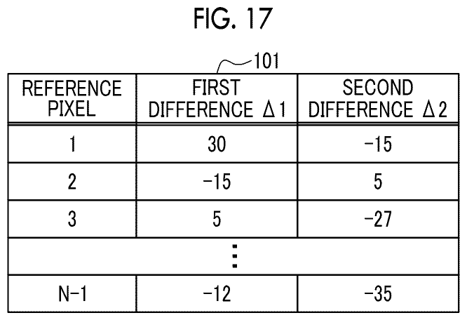

As illustrated in FIG. 17 as an example, the difference calculation unit 91 generates a difference calculation result 101 in which the first difference Δ1 and the second difference Δ2 are registered for each reference pixel 56R. The difference calculation unit 91 outputs the difference calculation result 101 to the change type determination unit 92 and the first comparison/counting unit 93.

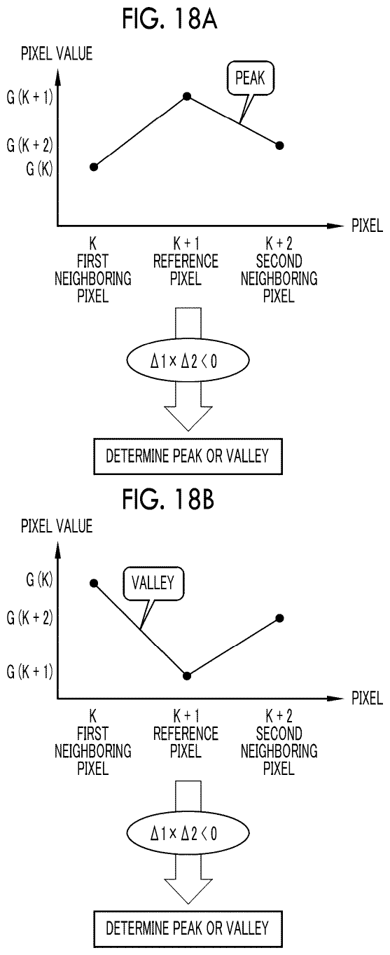

As illustrated in FIGS. 18A and 18B as an example, the change type determination unit 92 determines whether the change in the pixel values of the reference pixel 56R and the neighboring pixel 56NB forms the peak or the valley for each reference pixel 56R based on the difference calculation result 101. FIG. 18A illustrates a case of the peak, and FIG. 18B illustrates a case of the valley. The peak indicates a case where the pixel value of the reference pixel 56R is the highest and the pixel value of the neighboring pixel 56NB is lower than the pixel value of the reference pixel 56R, in other words, an inverted V type. The valley indicates a case where the pixel value of the reference pixel 56R is the lowest and the pixel value of the neighboring pixel 56NB is higher than the pixel value of the reference pixel 56R, in other words, a V type. The change type other than the peak and the valley is monotonic increase, monotonic decrease, or no change.

In both the peak and the valley, a combination of the signs of the first difference Δ1 and the second difference Δ2 is that one of the first difference Δ1 or the second difference Δ2 is positive and the other is negative. Therefore, the product of the first difference Δ1 and the second difference Δ2 is negative (Δ1×Δ2<0). By using these characteristics, the change type determination unit 92 determines that the change in the pixel values of the reference pixel 56R and the neighboring pixel 56NB forms the peak or the valley in a case where the product of the first difference Δ1 and the second difference Δ2 is negative. On the other hand, the change type determination unit 92 determines that the change in the pixel values of the reference pixel 56R and the neighboring pixel 56NB does not form the peak or the valley in a case where the product of the first difference Δ1 and the second difference Δ2 is zero or positive.

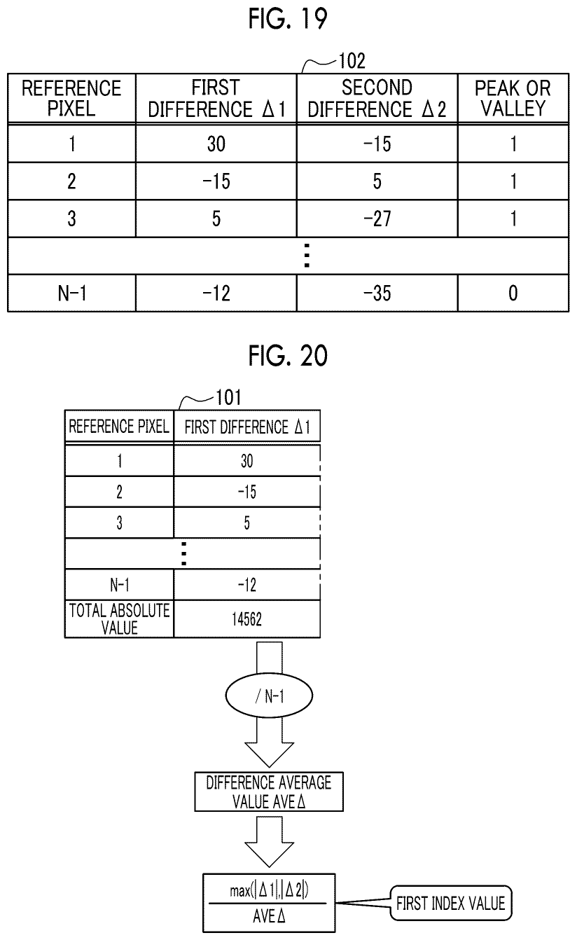

As illustrated in FIG. 19 as an example, the change type determination unit 92 generates a change type determination result 102 in which “1” is registered in the reference pixel 56R determined to have the change of the pixel value that forms the peak or the valley and “0” is registered in the reference pixel 56R determined not to have the change of the pixel value that forms the peak or the valley. The change type determination unit 92 outputs the change type determination result 102 to the first comparison/counting unit 93.

As illustrated in FIG. 20 as an example, the first comparison/counting unit 93 calculates a total absolute value of the first differences Δ1 of the difference calculation result 101 by adding the absolute values of all the first differences Δ1. The calculated total absolute value is split by N−1 to calculate a difference average value AVEΔ. The difference average value AVEΔ is an example of a “representative value of the difference” of the technology of the present disclosure. The “representative value of the difference” may be a mode value, a median value, or the like of the first difference Δ1 instead of the illustrated difference average value AVEΔ. The total absolute value of the first difference Δ1 is represented by the following expression (3).

$${Σ}_{K = 0}^{N - 2} \vert G ( K + 1 ) - G ( K ) \vert \qquad ( 3 )$$

The first comparison/counting unit 93 calculates a ratio max(|Δ1|, |Δ2|)/AVEΔ of a larger value max(|Δ1|, |Δ2|) of the absolute value of the first difference Δ1 and the absolute value of the second difference Δ2 to the difference average value AVEΔ for the reference pixel 56R determined to have the change of the pixel value that forms the peak or the valley. The ratio max(|Δ1|, |Δ2|)/AVEΔ is an example of a “first index value” of the technology of the present disclosure.

In FIG. 13, a first threshold value TH1 is input to the first comparison/counting unit 93. The first threshold value TH1 is a portion of the threshold value information 76. The first comparison/counting unit 93 determines whether the ratio max(|Δ1|, |Δ2|)/AVEΔ is larger than the first threshold value TH1 for the reference pixel 56R determined to have the change of the pixel value that forms the peak or the valley.

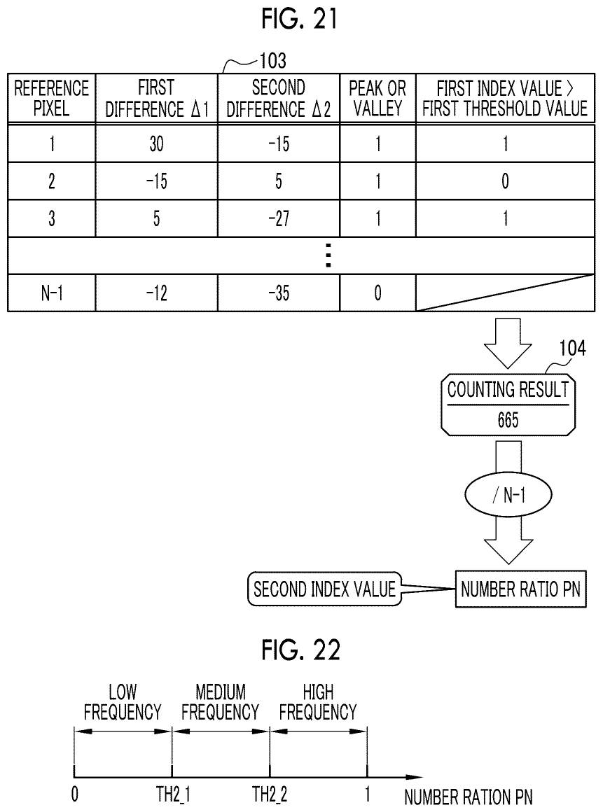

As illustrated in FIG. 21 as an example, the first comparison/counting unit 93 generates a first comparison result 103 in which “1” is registered in the reference pixel 56R determined to have the ratio max(|Δ1|, |Δ2|)/AVEΔ larger than the first threshold value TH1 and “0” is registered in the reference pixel 56R determined to have the ratio max(|Δ1|, |Δ2|)/AVEΔ equal to or smaller than the first threshold value TH1. The first comparison/counting unit 93 counts the number of reference pixels 56R determined to have the ratio max(|Δ1|, |Δ2|)/AVEΔ larger than the first threshold value TH1. The first comparison/counting unit 93 outputs a counting result 104 of the number to the second comparison unit 94.

In FIG. 13, a second_1 threshold value TH2_1 and a second_2 threshold value TH2_2 are input to the second comparison unit 94. Each of the second_1 threshold value TH2_1 and the second_2 threshold value TH2_2 is a part of the threshold value information 76. In FIG. 21, the second comparison unit 94 calculates a number ratio PN by dividing the counting result 104 by N−1. N−1 is an example of a “total number of the phase-difference detection pixels related to calculation of the difference” of the technology of the present disclosure. The number ratio PN is an example of a “second index value” of the technology of the present disclosure. The “total number of the phase-difference detection pixels related to calculation of the difference” is strictly N. However, since the difference Δ is actually calculated by N−1 difference calculation pixels 56D of the first to (N−1)th difference calculation pixels 56D as described above, N−1 is used as the “total number of the phase-difference detection pixels related to calculation of the difference”.

As illustrated in FIG. 22 as an example, the second_1 threshold value TH2_1 is a threshold value for determining a case where the level of the low-frequency component of the focus detection region 65 is relatively high (referred to as low frequency in FIG. 22) and a case where the level of the medium-frequency component of the focus detection region 65 is relatively high (referred to as medium frequency in FIG. 22). The second_2 threshold value TH2_2 is a threshold value for determining a case where the level of the medium-frequency component of the focus detection region 65 is relatively high and a case where the level of the high-frequency component of the focus detection region 65 is relatively high (referred to as high frequency in FIG. 22). Accordingly, the second_1 threshold value TH2_1 is lower than the second_2 threshold value TH2_2.

The second comparison unit 94 compares the number ratio PN with the second_1 threshold value TH2_1 and the second_2 threshold value TH2_2. In a case where the number ratio PN is equal to or larger than zero and smaller than the second_1 threshold value TH2_1 (0≤PN<TH2_1), the second comparison unit 94 determines that the level of the low-frequency component of the focus detection region 65 is relatively high. In a case where the number ratio PN is equal to or larger than the second_1 threshold value TH2_1 and smaller than the second_2 threshold value TH2_2 (TH2_1≤PN<TH2_2), the second comparison unit 94 determines that the level of the medium-frequency component of the focus detection region 65 is relatively high. In a case where the number ratio PN is equal to or larger than the second_2 threshold value TH2_2 and equal to or smaller than 1 (TH2_2≤PN≤1), the second comparison unit 94 determines that the level of the high-frequency component of the focus detection region 65 is relatively high. The second comparison unit 94 outputs any one of the three determination results 86 (see FIGS. 28A to 28C).

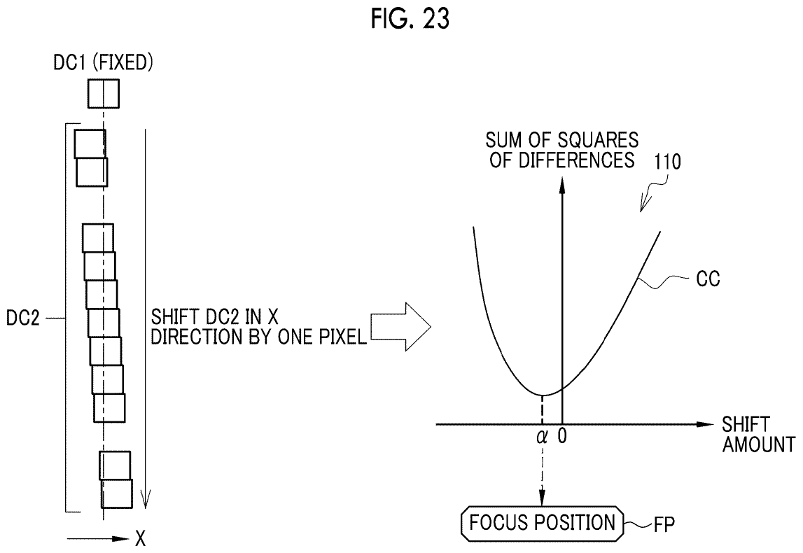

As illustrated in FIG. 23 as an example, the detection unit 81 detects the focus position FP roughly as follows. That is, the detection unit 81 fixes the first calculation data DC1, and shifts the second calculation data DC2 by one pixel in the X direction. Each time the shifting is performed, a sum of squares of differences between the first calculation data DC1 and the second calculation data DC2 is calculated. Instead of the sum of squares of differences, the sum of absolute values of differences or normalized mutual correlation may be calculated.

In a graph 110, a horizontal axis represents the shift amount of the second calculation data DC2, and a vertical axis represents the sum of squares of differences. In the graph 110, a correlation curve CC is a line connecting plots of the sum of squares of differences at each shift amount. In this correlation curve CC, the shift amount at which the sum of squares of differences is minimized is the phase difference α. The detection unit 81 detects the focus position FP from the phase difference α detected by correlation calculation.

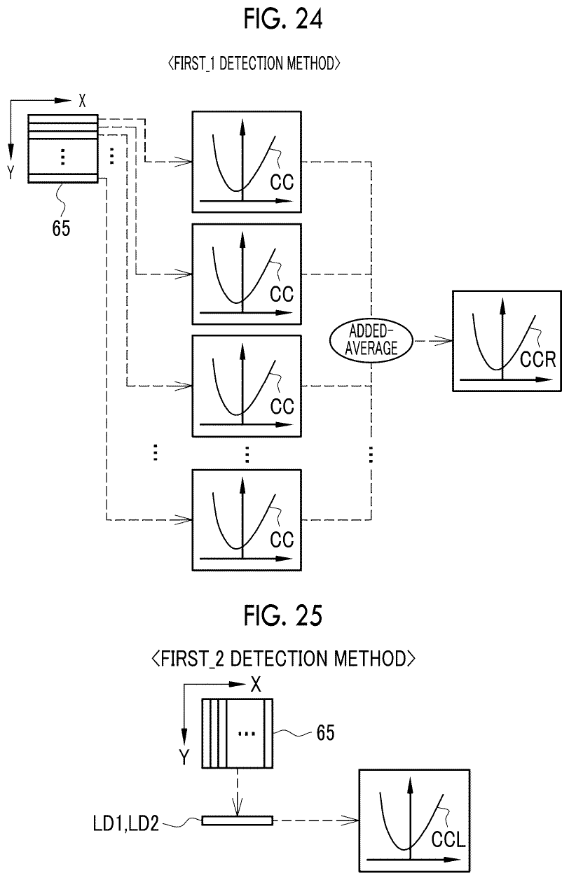

As illustrated in FIGS. 24 to 27 as an example, the detection unit 81 detects the focus position FP in accordance with any one of a first_1 detection method, a first_2 detection method, a first_3 detection method, or the second detection method. The first_1 detection method, the first_2 detection method, and the first_3 detection method are examples of a “first detection method” of the technology of the present disclosure.

As illustrated in FIG. 24, in the first_1 detection method, the detection unit 81 performs the correlation calculation on each line of the focus detection region 65. Therefore, the detection unit 81 obtains a plurality of correlation curves CC corresponding to each line of the focus detection region 65. The detection unit 81 adds and averages the plurality of correlation curves CC to aggregate the correlation curves CC into one correlation curve CCR.

As illustrated in FIG. 25, in the first_2 detection method, the detection unit 81 calculates second line data LD2, which is a set of addition-averaged values of the plurality of second calculation signals 572P arranged in the Y direction, by the same method as the first line data LD1 illustrated in FIG. 14. The detection unit 81 performs the correlation calculation on the first line data LD1 and the second line data LD2. Accordingly, the detection unit 81 obtains only one correlation curve CCL corresponding to the first line data LD1 and the second line data LD2.

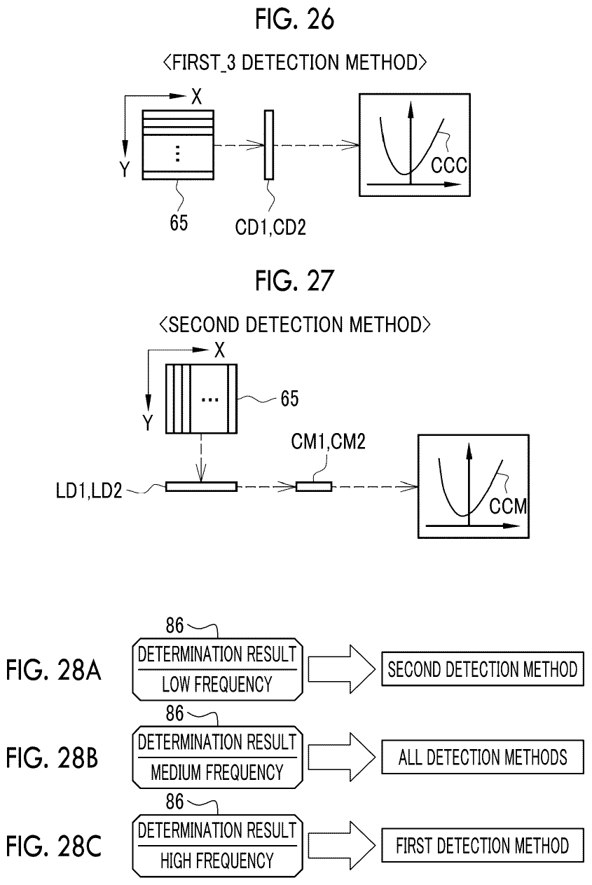

As illustrated in FIG. 26, in the first_3 detection method, the detection unit 81 calculates first column data CD1, which is a set of addition-averaged values of each line, by calculating the addition-averaged value of the plurality of first calculation signals 571P arranged in the X direction for each line of the first calculation data DCL. Similarly, the detection unit 81 calculates second column data CD2, which is a set of addition-averaged values of each line, by calculating the addition-averaged value of the plurality of second calculation signals 572P arranged in the X direction. The detection unit 81 performs the correlation calculation on the first column data CD1 and the second column data CD2. Accordingly, the detection unit 81 obtains only one correlation curve CCC corresponding to the first column data CD1 and the second column data CD2.

As illustrated in FIG. 27 as an example, in the second detection method, the detection unit 81 calculates an addition-averaged value of the addition-averaged values (difference calculation pixel values) of two adjacent unit components (difference calculation pixels 56D) of the first line data LD1. Specifically, the detection unit 81 calculates an addition-averaged value of the difference calculation pixel values G(1) and G(2), an addition-averaged value of the difference calculation pixel values G(3) and G(4), an addition-averaged value of the difference calculation pixel values G(5) and G(6), and the like. The detection unit 81 obtains first compression data CM1 obtained by compressing the first line data LD1 by ½ in the X direction in this manner. Further, the detection unit 81 also calculates an addition-averaged value of the addition-averaged values of two adjacent unit components for the second line data LD2. The detection unit 81 obtains second compression data CM2 obtained by compressing the second line data LD2 by ½ in the X direction in this manner. The detection unit 81 performs the correlation calculation on the first compression data CM1 and the second compression data CM2. Accordingly, the detection unit 81 obtains only one correlation curve CCM corresponding to the first compression data CM1 and the second compression data CM2.

As illustrated in FIGS. 28A to 28C as an example, the detection unit 81 determines the detection method of the focus position FP in accordance with the determination result 86. That is, as illustrated in FIG. 28A, in a case where the determination result 86 is that the level of the low-frequency component of the focus detection region 65 is relatively high (referred to as low frequency in FIGS. 28A to 28C), the detection unit 81 detects the focus position FP in accordance with the second detection method. More specifically, the detection unit 81 detects the phase difference α from the correlation curve CCM illustrated in FIG. 27, and further detects the focus position FP.

As illustrated in FIG. 28B, in a case where the determination result 86 indicates that the level of the medium-frequency component of the focus detection region 65 is relatively high (referred to as medium frequency in FIGS. 28A to 28C), the detection unit 81 detects the focus position FP in accordance with all the detection methods (first_1 detection method, first_2 detection method, first_3 detection method, and second detection method).

As illustrated in FIG. 28C, in a case where the determination result 86 indicates that the level of the high-frequency component of the focus detection region 65 is relatively high (referred to as high frequency in FIGS. 28A to 28C), the detection unit 81 detects the focus position FP in accordance with the first detection methods (first_1 detection method, first_2 detection method, and first_3 detection method).

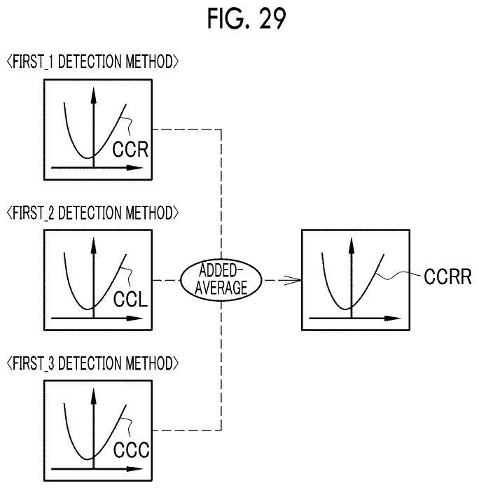

As illustrated in FIG. 29 as an example, in a case of detecting the focus position FP in accordance with the first detection method of FIG. 28C, the detection unit 81 adds and averages the correlation curve CCR obtained by the first_1 detection method, the correlation curve CCL obtained by the first_2 detection method, and the correlation curve CCC obtained by the first_3 detection method to aggregate these correlation curves into one correlation curve CCRR. The detection unit 81 detects the phase difference α from the correlation curve CCRR and further detects the focus position FP. The correlation curves CCR, CCL, and CCC are examples of “detection reference information” of the technology of the present disclosure. Although not illustrated, in a case of detecting the focus position FP in accordance with all the detection methods of FIG. 28B, the detection unit 81 adds and averages the correlation curve CCM obtained by the second detection method to the correlation curves CCR, CCL, and CCC to aggregate these correlation curves into one correlation curve, detects the phase difference α from the aggregated correlation curve, and further detects the focus position FP.

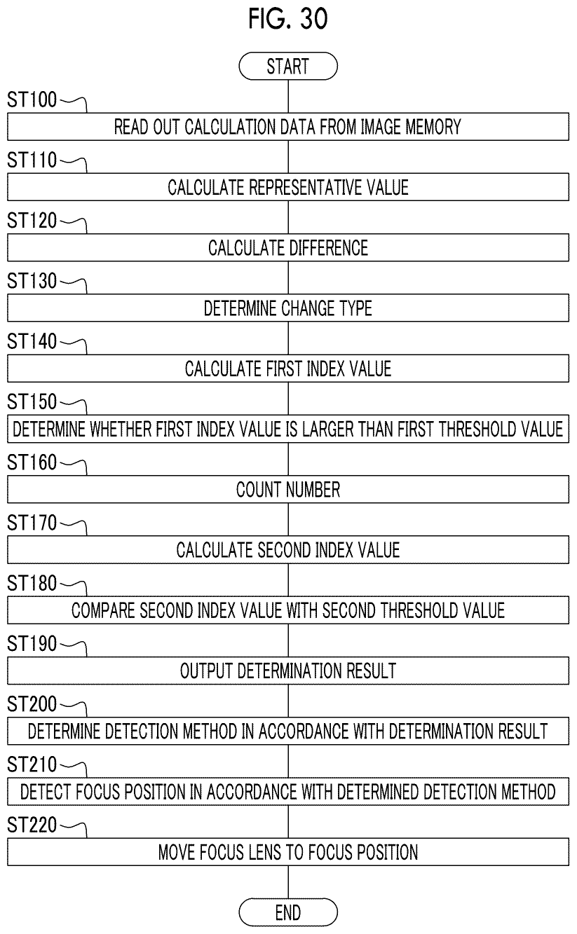

Next, an operation of the above configuration will be described with reference to a flowchart illustrated in FIG. 30 as an example. As illustrated in FIG. 12, the CPU 71 of the controller 32 functions as the focus controller 78 as the operation program 75 is started up. The focus controller 78 includes the determination unit 80, the detection unit 81, and the focus lens drive controller 82. As illustrated in FIG. 13, the determination unit 80 functions as the representative value calculation unit 90, the difference calculation unit 91, the change type determination unit 92, the first comparison/counting unit 93, and the second comparison unit 94.

Under the control of the controller 32, the imaging element 19 performs the accumulation operation of the signal charges corresponding to the subject light. Then, the readout operation of the image signals 57 corresponding to the signal charges is performed. The image signals 57 are stored in the image memory 41 via the image input controller 40. The image signals 57 are subjected to various types of image processing by the image processing unit 42, and then written back to the image memory 41.

In the focus controller 78, the calculation data DC is read out from the image memory 41 to the determination unit 80 (step ST100). In the determination unit 80, first, as illustrated in FIG. 14, the representative value calculation unit 90 calculates the first line data LD1, which is a set of addition-averaged values of each column, from the first calculation data DC1 (step ST110). The first line data LD1 is output from the representative value calculation unit 90 to the difference calculation unit 91, as the representative value calculation result 100.

As illustrated in FIGS. 15A to 15C, the difference calculation unit 91 calculates the first difference Δ1 between the pixel value G(K+1) of the reference pixel 56R and the pixel value G(K) of the first neighboring pixel 56NB1, and the second difference Δ2 between the pixel value G(K+1) of the reference pixel 56R and the pixel value G(K+2) of the second neighboring pixel 56NB2 for each difference calculation pixel 56D of the first line data LD1 (step ST120).

The difference calculation results 101 of the first difference Δ1 and the second difference Δ2 are output from the difference calculation unit 91 to the change type determination unit 92 and the first comparison/counting unit 93.

As illustrated in FIGS. 18A and 18B, the change type determination unit 92 determines whether the change in the pixel values of the reference pixel 56R and the neighboring pixel 56NB forms the peak or the valley (step ST130). The change type determination result 102 is output from the change type determination unit 92 to the first comparison/counting unit 93.

As illustrated in FIG. 20, in the first comparison/counting unit 93, the total absolute value of the first difference Δ1 is calculated from the difference calculation result 101, and the difference average value AVEΔ is calculated by further dividing the total absolute value by N−1. Then, for the reference pixel 56R determined to have the change of the pixel value that forms the peak or the valley, the ratio max(|A1, |A2|)/AVEΔ of a larger value max(|A1, |A2|) of the absolute value of the first difference Δ1 and the absolute value of the second difference Δ2 to the difference average value AVEΔ is calculated as the first index value (step ST140).

As illustrated in FIG. 21, in the first comparison/counting unit 93, it is determined whether the ratio max(|Δ1|, |Δ2|)/AVEΔ is larger than the first threshold value TH1 for the reference pixel 56R determined to have the change of the pixel value that forms the peak or the valley, and the first comparison result 103 is generated (step ST150). The number of reference pixels 56R determined to have the ratio max(|Δ1|, |Δ2|)/AVEΔ larger than the first threshold value TH1 is counted (step ST160). The counting result 104 of the number is output to the second comparison unit 94 from the first comparison/counting unit 93.

As illustrated in FIG. 21, in the second comparison unit 94, the counting result 104 is split by N−1, and the number ratio PN as the second index value is calculated (step ST170). Then, as illustrated in FIG. 22, the number ratio PN is compared with the second_1 threshold value TH2_1 and the second_2 threshold value TH2_2 (step ST180). The determination result 86 of the content corresponding to this comparison result is output from the second comparison unit 94 to the detection unit 81 (step ST190).

As illustrated in FIGS. 28A to 28C, in the detection unit 81, the detection method of the focus position FP is determined in accordance with the determination result 86 (step ST200). Specifically, in a case where the determination result 86 indicates that the level of the low-frequency component of the focus detection region 65 is relatively high, the second detection method is determined. In a case where the determination result 86 indicates that the level of the medium-frequency component of the focus detection region 65 is relatively high, all the detection methods are determined. In a case where the determination result 86 indicates that the level of the high-frequency component of the focus detection region 65 is relatively high, the first detection method is determined.

In the detection unit 81, the focus position FP is detected in accordance with the determined detection method (step ST210). In a case where the plurality of detection methods are determined, as illustrated in FIG. 29, in the detection unit 81, the correlation curves obtained by the plurality of detection methods are aggregated, and the focus position FP is detected from the aggregated correlation curve. The focus position FP is output to the focus lens drive controller 82 from the detection unit 81. In the focus controller 78, the current position of the focus lens 26 is detected based on the drive amount 85 of the focus motor from the focus lens drive mechanism 28.

The focus lens 26 is moved from the current position to the focus position FP under the control of the focus lens drive controller 82 (step ST220).

In this way, the CPU 71 of the controller 32 functions as the determination unit 80 and the detection unit 81. The determination unit 80 calculates the difference Δ between the pixel value G(K+1) of the reference pixel 56R and the pixel values G(K) and G(K+2) of the neighboring pixels 56NB present within a preset neighboring range with respect to the reference pixel 56R, the difference Δ being a difference for the plurality of phase-difference detection pixels 56P arranged in the focus detection region 65. The detection unit 81 determines the detection method of the focus position FP of the focus lens 26 in accordance with the difference Δ. In accordance with the difference Δ, it is possible to directly determine whether the subject in the focus detection region 65 is a subject having a relatively high high-frequency component, a subject having a relatively high medium-frequency component, or a subject having a relatively high low-frequency component, as compared with a method using the Fourier transform described in WO2015/146228A. Accordingly, the determination accuracy of the level of the frequency component of the focus detection region 65 can be improved. As a result, it is possible to contribute to detecting an accurate focus position FP.

As illustrated in FIGS. 15A to 15C, the reference pixel 56R and the neighboring pixel 56NB are arranged on the same line. As the neighboring pixel 56NB, there are two neighboring pixels 56NB of one neighboring pixel located in the XA direction and one neighboring pixel located in the XB direction opposite to the XA direction with respect to the reference pixel 56R. The difference Δ is the first difference Δ1 between the pixel value G(K+1) of the reference pixel 56R and the pixel value G(K) of the first neighboring pixel 56NB1, which is one of the two neighboring pixels 56NB. In addition, the difference Δ is the second difference Δ2 between the pixel value G(K+1) of the reference pixel 56R and the pixel value G(K+2) of the second neighboring pixel 56NB2, which is the other of the two neighboring pixels 56NB. Therefore, the change in the pixel values of the reference pixel 56R and the neighboring pixel 56NB in the X direction can be accurately detected. In addition, by disposing the neighboring pixel 56NB across the reference pixel 56R, it is possible to determine whether the change in the pixel values of the reference pixel 56R and the neighboring pixel 56NB forms the peak or the valley.

As illustrated in FIGS. 15A to 15C, the first neighboring pixel 56NB1 and the second neighboring pixel 56NB2 are located symmetrically with respect to the reference pixel 56R. Therefore, the change in the pixel values of the reference pixel 56R and the neighboring pixel 56NB can be detected without bias, as compared to a case where the first neighboring pixel 56NB1 and the second neighboring pixel 56NB2 are located asymmetrically.

The reference pixel 56R, the first neighboring pixel 56NB1, and the second neighboring pixel 56NB2 are adjacent to one another. Therefore, the change in the pixel values of the reference pixel 56R and the neighboring pixel 56NB can be detected in units of one pixel. The determination accuracy of the level of the frequency component of the focus detection region 65 can be further improved. The reference pixel 56R, the first neighboring pixel 56NB1, and the second neighboring pixel 56NB2 do not always have to be adjacent to one another.

As illustrated in FIGS. 15A to 15C and FIG. 16, the first difference Δ1 is a difference (G(K+1)−G(K)) between the pixel value G(K+1) of the reference pixel and the pixel value G(K) of the first neighboring pixel 56NB1. Further, the second difference Δ2 is a difference (G(K+2)−G(K+1)) between the pixel value G(K+2) of the second neighboring pixel 56NB2 and the pixel value G(K+1) of the reference pixel 56R. Therefore, the first difference Δ1 and the second difference Δ2 can be calculated easily.

As illustrated in FIGS. 18A and 18B to FIG. 22 and FIGS. 28A to 28C, the detection unit 81 determines the detection method in accordance with a combination of the signs of the first difference Δ1 and the second difference Δ2. More specifically, as illustrated in FIGS. 18A and 18B, the change type determination unit 92 determines whether the change in the pixel values of the reference pixel 56R and the neighboring pixel 56NB forms the peak or the valley based on the combination of the signs of the first difference Δ1 and the second difference Δ2. As illustrated in FIG. 20, the first comparison/counting unit 93 calculates the ratio max(|Δ1|, |Δ2|)/AVEΔ as the first index value of the reference pixel 56R and the neighboring pixel 56NB determined to have the change that forms the peak or the valley. As illustrated in FIG. 21, the first comparison/counting unit 93 determines whether the ratio max(|Δ1|, |Δ2|)/AVEΔ is larger than the first threshold value TH1. The first comparison/counting unit 93 counts the number of reference pixels 56R determined to have the ratio max(|Δ1|, |Δ2|)/AVEΔ larger than the first threshold value TH1. The second comparison unit 94 calculates the number ratio PN as the second index value. As illustrated in FIG. 22, the second comparison unit 94 determines the level of the frequency component of the focus detection region 65 based on the comparison between the number ratio PN and the second_1 threshold value TH2_1 and the second_2 threshold value TH2_2. As illustrated in FIGS. 28A to 28C, the detection unit 81 determines the detection method in accordance with the determination result 86 of the level of the frequency component of the focus detection region 65.

The change in the pixel values of the reference pixel 56R and the neighboring pixel 56NB forming the peak or the valley means that the pixel values of the reference pixel 56R and the neighboring pixel 56NB locally show a steep change. Then, the ratio max(|Δ1|, |Δ2|)/AVEΔ indicating the magnitude of the change that forms the peak or the valley being larger than the first threshold value TH1 means that the degree of the steep change is larger than a specified value. The number ratio PN indicates how many steep changes having a degree larger than the specified value are present. Accordingly, in a case where the number ratio PN is relatively low, it can be said that the level of the low-frequency component of the subject is relatively high, and in a case where the number ratio PN is relatively high, it can be said that the level of the high-frequency component of the subject is relatively high. In accordance with the determination through such a plurality of stages, the determination accuracy can be further improved.

As illustrated in FIG. 20, the first index value is the ratio max(|Δ1|, |Δ2|)/AVEΔ of a larger value max(|Δ1|, |Δ2|) of the first difference Δ1 and the second difference Δ2 to the difference average value AVEΔ as the representative value of the difference Δ. By normalizing the degree of the change in the pixel values of the reference pixel 56R and the neighboring pixel 56NB in this manner, the degree of the change in the pixel values of the reference pixel 56R and the neighboring pixel 56NB can be appropriately evaluated. It is possible to suppress the influence of the pixel value that changes locally and the pixel value that is extremely large or small. In addition, the first index value may be a larger value (max(|Δ1|, |Δ2|) of the first difference Δ1 and the second difference Δ2.

As illustrated in FIG. 21, the second index value is a ratio (number ratio PN) of the number of reference pixels 56R determined to have the ratio max(|Δ1|, |Δ2|)/AVEΔ larger than the first threshold value TH1 to the total number N−1 of the difference calculation pixels 56D. Therefore, even in a case where the size of the focus detection region 65 is changed and the total number N−1 of the difference calculation pixels 56D is changed, the level of the frequency component of the focus detection region 65 can be determined by the same second_1 threshold value TH2_1 and second_2 threshold value TH2_2. In a case where the size of the focus detection region 65 is fixed and the total number N−1 of the difference calculation pixels 56D is also fixed, the second index value may be the number of reference pixels 56R determined to have the ratio max(|Δ1|, |Δ2|)/AVEΔ larger than the first threshold value TH1.

As illustrated in FIG. 22, the determination unit 80 determines the level of the frequency component of the focus detection region 65 based on the comparison result between the number ratio PN and the second_1 threshold value TH2_1 and the second_2 threshold value TH2_2. As illustrated in FIGS. 28A to 28C, the detection unit 81 determines the detection method in accordance with the determination result 86 of the level. Accordingly, the focus position FP can be detected by the detection method suitable for the level.

As illustrated in FIGS. 28A to 28C, in a case where the determination result 86 indicates that the level of the high-frequency component of the focus detection region 65 is relatively high, the detection unit 81 detects the focus position FP in accordance with the first detection method. On the other hand, in a case where the determination result 86 indicates that the level of the low-frequency component of the focus detection region 65 is relatively high, the detection unit 81 detects the focus position FP in accordance with the second detection method different from the first detection method. Therefore, the focus position FP can be detected by the detection method suitable for each of a case where the level of the high-frequency component of the focus detection region 65 is relatively high and a case where the level of the low-frequency component of the focus detection region 65 is relatively high.

A case where the level of the low-frequency component is relatively high is, for example, a case of a large blur with low contrast. In such a case, it is preferable to detect a rough focus position FP rather than an accurate focus position FP. As illustrated in FIG. 27, in the second detection method, the correlation calculation is performed on the first compression data CM1 and the second compression data CM2 obtained by further compressing the first line data LD1 and the second line data LD2 obtained by compressing the first calculation data DC1 and the second calculation data DC2. Therefore, in a case where the determination result indicates that the level of the low-frequency component of the focus detection region 65 is relatively high, the detection unit 81 detects the focus position FP in accordance with the second detection method.

As illustrated in FIGS. 28A to 28C, in a case where the determination result 86 indicates that the level of the medium-frequency component of the focus detection region 65 is relatively high, the detection unit 81 detects the focus position FP in accordance with the first detection method and the second detection method. A case where the level of the medium-frequency component is relatively high is a case where it cannot be said that the level of the high-frequency component is high or the level of the low-frequency component is high, and includes the features of both a case where the level of the high-frequency component is high and a case where the level of the low-frequency component is high. Therefore, in a case where the determination result indicates that the level of the medium-frequency component of the focus detection region 65 is relatively high, the focus position FP is detected in accordance with the first detection method and the second detection method to improve the detection accuracy of the focus position FP.

As illustrated in FIGS. 24 to 26, there are a plurality of first detection methods. As illustrated in FIG. 29, the detection unit 81 aggregates the correlation curves (correlation curves CCR, CCL, and CCC) of the plurality of first detection methods. Accordingly, the detection accuracy of the focus position FP can be further improved. In a case of aggregating the correlation curves of the plurality of first detection methods, a weighted average may be used instead of the illustrated addition average. In this case, for example, the weight of the correlation curve CCR may be 0.5, and the weight of each of the correlation curves CCL and CCC may be 0.25.

As illustrated in FIG. 14 and FIGS. 15A to 15C, the pixel value of the reference pixel 56R and the pixel value of the neighboring pixel 56NB are representative values of the pixel values of the plurality of phase-difference detection pixels 56P. Therefore, it is possible to suppress the influence of the pixel value that changes locally and the pixel value that is extremely large or small.

### Second Embodiment

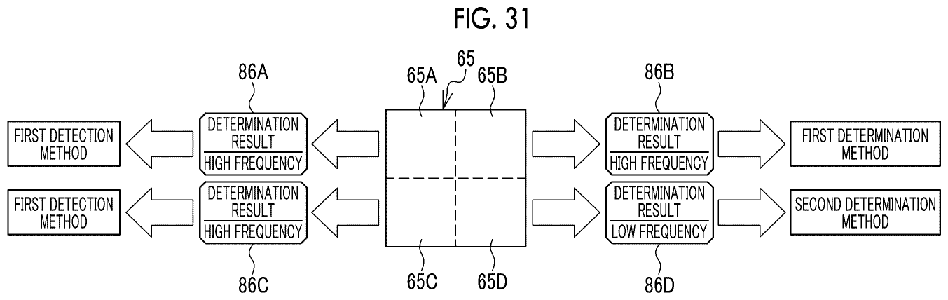

As illustrated in FIG. 31 as an example, in the second embodiment, the focus detection region 65 is split into the plurality of split regions, here, four split regions 65A, 65B, 65C, and 65D. In this case, the determination unit 80 determines the level of the frequency component for each of the split regions 65A to 65D, and outputs determination results 86A, 86B, 86C, and 86D for each of the split regions 65A to 65D. The detection unit 81 determines the detection method of the focus position FP for each of the split regions 65A to 65D in accordance with each determination result 86A to 86D. The detection unit 81 aggregates the correlation curves obtained by the detection methods determined in each of the split regions 65A to 65D, and detects the focus position FP from the aggregated correlation curve. FIG. 31 illustrates an example of a case where the split regions 65A to 65C are determined to have a relatively high level of the high-frequency component and are determined to have the first detection method, and the split region 65D is determined to have a relatively high level of the low-frequency component and is determined to have the second detection method.

By determining the level for each of the plurality of split regions 65A to 65D in this way and determining the detection method for each of the plurality of split regions 65A to 65D, it is possible to perform more flexible focus control in accordance with various imaging scenes.

The number of splits of the focus detection region 65 is not limited to the example of 4, and may be 2, 6, 8, 9, 16, or the like.

### Third_1 Embodiment

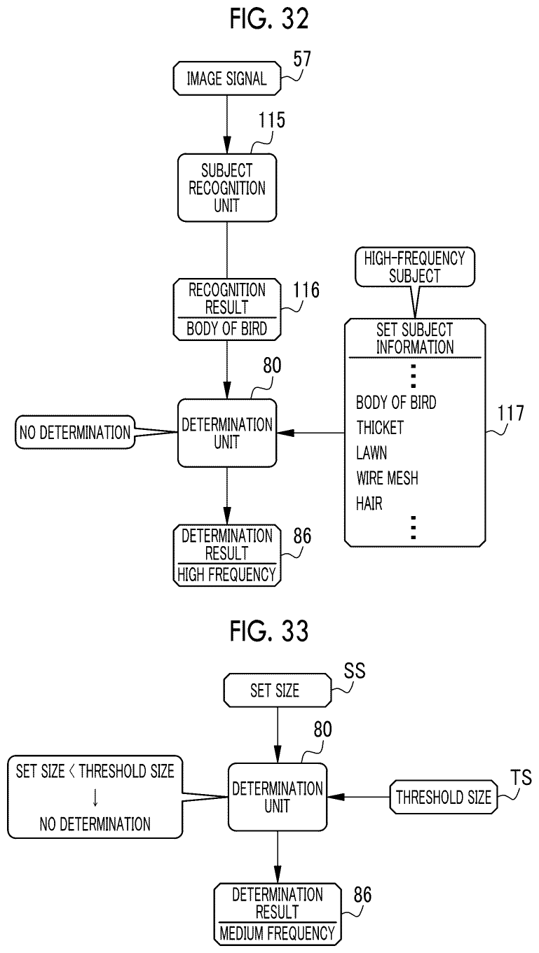

As illustrated in FIG. 32 as an example, in the third_1 embodiment, a subject recognition unit 115 is provided before the determination unit 80. The image signal 57 is input to the subject recognition unit 115. The subject recognition unit 115 recognizes the subject in the focus detection region 65 of the image represented by the image signal 57 by using, for example, a subject recognition technique using a trained model such as a semantic segmentation model. The subject recognition unit 115 outputs a recognition result 116 of the subject to the determination unit 80.

The set subject information 117 is input to the determination unit 80. The set subject information 117 is, for example, information on a subject having a relatively high level of the high-frequency component, such as a body of a bird, a lawn, and a wire mesh. In a case where the subject of the recognition result 116 is not present in the set subject information 117, the determination unit 80 determines the level of the frequency component of the focus detection region 65. On the other hand, in a case where the subject of the recognition result 116 is present in the set subject information 117, the determination unit 80 outputs the determination result 86 indicating that the level of the high-frequency component of the focus detection region 65 is relatively high, without determining the level of the frequency component of the focus detection region 65. A case where the subject of the recognition result 116 is present in the set subject information 117 is an example of a “case where a set condition is satisfied” of the technology of the present disclosure.

### Third_2 Embodiment

As illustrated in FIG. 33 as an example, in the third_2 embodiment, a set size SS and a threshold size TS of the focus detection region 65 are input to the determination unit 80. The determination unit 80 compares the set size SS with the threshold size TS. In a case where the set size SS is equal to or larger than the threshold size TS (SS≥TS), the determination unit 80 determines the level of the frequency component of the focus detection region 65. On the other hand, in a case where the set size SS is smaller than the threshold size TS (SS<TS), the determination unit 80 outputs the determination result 86 indicating that the level of the medium-frequency component of the focus detection region 65 is relatively high, without determining the level of the frequency component of the focus detection region 65. The threshold size TS is a size at which the determination accuracy of the level of the frequency component of the focus detection region 65 is outside the allowable range. A case where the set size SS is smaller than the threshold size TS is an example of a “case where a set condition is satisfied” of the technology of the present disclosure.

As described above, in the third_1 embodiment and the third_2 embodiment, in a case where the set condition is satisfied, the determination unit 80 does not determine the level of the frequency component of the focus detection region 65. Accordingly, the processing load of the determination unit 80 can be reduced. By not performing the unnecessary processing, the detection of the focus position FP and the movement of the focus lens 26 to the focus position FP can be quickly completed.

In the third_1 embodiment, in a case where the subject in the focus detection region 65 is the set subject, the level of the frequency component of the focus detection region 65 is not determined. In this way, it is possible to avoid performing the unnecessary processing on the subject of which the level of the frequency component is known.

In a case where the set subject is a subject having a relatively high level of the high-frequency component, it is possible to avoid performing the unnecessary processing on the subject of which the level of the high-frequency component is known to be relatively high. In addition, the set subject may be a subject having a relatively high level of the low-frequency component.

In the third_2 embodiment, in a case where the focus detection region 65 smaller than the threshold size TS is set, the level of the frequency component of the focus detection region 65 is not determined. In a case where the focus detection region 65 is smaller than the threshold size TS, even a subject having a relatively high level of the high-frequency component from a macroscopic viewpoint does not have a relatively high level of the high-frequency component from a microscopic viewpoint, and the level of the frequency component cannot be accurately determined. Therefore, in a case where the focus detection region 65 smaller than the threshold size TS is set, the level of the frequency component of the focus detection region 65 is not determined, so that the erroneous determination of the level of the frequency component is reduced, which may result in the detection of the inaccurate focus position FP.

As the plurality of first detection methods, the first_1 detection method, the first_2 detection method, and the first_3 detection method have been described, but the present disclosure is not limited to this. The plurality of first detection methods may be two detection methods of the first_1 detection method and the first_2 detection method or two detection methods of the first_1 detection method and the first_3 detection method.

It may be recognized whether the subject in the focus detection region 65 includes a diagonal line or a repeated pattern, a vertical line, or a horizontal line, and the detection method may be determined in accordance with the recognition result. Specifically, in a case where it is recognized that the subject in the focus detection region 65 includes a diagonal line or a repeated pattern, the first_1 detection method is determined. In a case where it is recognized that the subject in the focus detection region 65 includes a vertical line, the first_2 detection method is determined. In a case where it is recognized that the subject in the focus detection region 65 includes a horizontal line, the first 3 detection method is determined.

The imaging device of the technology of the present disclosure is not limited to the illustrated digital camera, and may also be a video camera, a surveillance camera, a smartphone, or a tablet terminal.

In each of the above embodiments, for example, each processing of each processing unit such as the image processing unit 42, the display controller 45, the instruction reception unit 47, the focus controller 78, the determination unit 80, the detection unit 81, the focus lens drive controller 82, the representative value calculation unit 90, the difference calculation unit 91, the change type determination unit 92, the first comparison/counting unit 93, the second comparison unit 94, and the subject recognition unit 115 is executed by any computer. In addition, any computer may execute these types of processing using a processor as hardware, a program as software, or a combination thereof. In such a case, the processor is configured to execute various types of processing in each of the above embodiments in cooperation with the program, and may function as each unit or each means in each of the above embodiments. The order in which the processes are executed by the processor is not limited to the order described above and may be changed as appropriate. Any computer may be a general-purpose computer, a computer for a specific use, a workstation, or another system capable of executing each processing.

The processor may be configured by one or more hardware components, and the types of the hardware components are not limited. For example, the processor may be configured by a programmable logic device such as the illustrated CPU 71, a micro processing unit (MPU), or a field programmable gate array (FPGA), a dedicated circuit for executing specific processing such as an application specific integrated circuit (ASIC), or hardware such as a graphics processing unit (GPU) or a neural processing unit (NPU). In addition, the types of the hardware components may be a combination of different types of hardware components. In a case where a plurality of hardware components are configured to execute one or a plurality of processes of a certain processor, the plurality of hardware components may be present in devices physically separated from each other, or may be present in the same device. In addition, in any of the embodiments, the order of each of the processes executed by the processor is not limited to the above order and may be changed as appropriate. In addition, the hardware is configured by an electric circuit (circuitry) in which circuit elements such as semiconductor elements are combined.

Furthermore, the program may be software such as firmware or a microcode. In addition, the program may be, for example, a program module group, and each function thereof may be achieved by a processor configured to execute each function. The program may be a program code or a plurality of code segments stored in one or a plurality of non-transitory computer-readable media (for example, a storage medium or other storages). The program may be divided and stored in a plurality of non-transitory computer-readable media existing in devices physically separated from each other. The program code or the code segment may represent any combination of a procedure, a function, a subprogram, a routine, a subroutine, a module, a software package, a class, an instruction, a data structure, and a program statement.

The program code or the code segment may be connected to another code segment or a hardware circuit by transmitting and receiving information, data, an argument, a parameter, or memory content.

It is possible to understand the technologies described in the following supplementary notes from the above description.

### Supplementary Note 1

A focus control device comprising: a processor configured to determine a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

### Supplementary Note 2

The focus control device according to supplementary note 1, in which the reference pixel and the neighboring pixel are arranged on the same line, as the neighboring pixel, there are two neighboring pixels of one neighboring pixel located in a first direction of the line and one neighboring pixel located in a second direction opposite to the first direction with respect to the reference pixel, and as the difference, there are a first difference between the pixel value of the reference pixel and a pixel value of one of the two neighboring pixels, and a second difference between the pixel value of the reference pixel and a pixel value of the other of the two neighboring pixels.

### Supplementary Note 3

The focus control device according to supplementary note 2, in which the two neighboring pixels are located symmetrically with respect to the reference pixel.

### Supplementary Note 4

The focus control device according to supplementary note 3, in which the reference pixel and the two neighboring pixels are adjacent to each other.

### Supplementary Note 5

The focus control device according to supplementary note 4, in which, in a case where the pixel value of the reference pixel is denoted by G(K+1), the pixel value of the one of the two neighboring pixels is denoted by G(K), the pixel value of the other of the two neighboring pixels is denoted by G(K+2), K is 0 to N−2, and N is a total number of the phase-difference detection pixels related to calculation of the difference, the first difference is G(K+1)−G(K), and the second difference is G(K+2)−G(K+1).

### Supplementary Note 6

The focus control device according to any one of supplementary notes 2 to 5, in which the processor is configured to determine the detection method in accordance with a combination of signs of the first difference and the second difference.

### Supplementary Note 7

The focus control device according to supplementary note 6, in which the processor is configured to determine whether a change in the pixel values of the reference pixel and the neighboring pixel forms a peak or a valley based on the combination.

### Supplementary Note 8

The focus control device according to supplementary note 7, in which the processor is configured to determine the detection method in accordance with the number of the reference pixels determined to have a first index value related to the first difference and the second difference larger than a first threshold value, the first index value being determined for the reference pixel and the neighboring pixel that are determined to have the change that forms the peak or the valley.

### Supplementary Note 9

The focus control device according to supplementary note 8, in which the first index value is a ratio between a larger value of the first difference and the second difference and a representative value of the difference.

### Supplementary Note 10

The focus control device according to supplementary note 8 or 9, in which the processor is configured to determine the detection method in accordance with a second index value related to the number.

### Supplementary Note 11

The focus control device according to supplementary note 10, in which the second index value is a ratio of the number to a total number of the phase-difference detection pixels related to calculation of the difference.

### Supplementary Note 12

The focus control device according to supplementary note 10 or 11, in which the processor is configured to determine a level of a frequency component of the focus detection region based on a comparison result between the second index value and a second threshold value, and determine the detection method in accordance with a determination result of the level.

### Supplementary Note 13

The focus control device according to supplementary note 12, in which the processor is configured to detect the focus position in accordance with a first detection method in a case where the determination result indicates that a level of a high-frequency component of the focus detection region is relatively high, and detect the focus position in accordance with a second detection method different from the first detection method in a case where the determination result indicates that a level of a low-frequency component of the focus detection region is relatively high.

### Supplementary Note 14

The focus control device according to supplementary note 13, in which the processor is configured to detect the focus position in accordance with the first detection method and the second detection method in a case where the determination result indicates that a level of a medium-frequency component of the focus detection region is relatively high.

### Supplementary Note 15

The focus control device according to supplementary note 13 or 14, in which there are a plurality of the first detection methods, and the processor is configured to aggregate detection reference information of the plurality of first detection methods.

### Supplementary Note 16

The focus control device according to any one of supplementary notes 12 to 15, in which the processor is configured to determine the level for each of a plurality of split regions obtained by splitting the focus detection region, and determine the detection method for each of the plurality of split regions.

### Supplementary Note 17

The focus control device according to any one of supplementary notes 12 to 16, in which the processor is configured not to determine the level in a case where a set condition is satisfied.

### Supplementary Note 18

The focus control device according to supplementary note 17, in which the processor is configured not to determine the level in a case where a subject in the focus detection region is a set subject.

### Supplementary Note 19

The focus control device according to supplementary note 18, in which the set subject is a subject having a relatively high level of a high-frequency component.

### Supplementary Note 20

The focus control device according to any one of supplementary notes 17 to 19, in which the processor is configured not to determine the level in a case where the focus detection region smaller than a threshold size is set.

### Supplementary Note 21

The focus control device according to any one of supplementary notes 1 to 20, in which the pixel value of the reference pixel and the pixel value of the neighboring pixel are representative values of pixel values of the plurality of phase-difference detection pixels.

### Supplementary Note 22

An imaging device comprising: the focus control device according to any one of supplementary notes 1 to 21.

The technology of the present disclosure can also be appropriately combined with various embodiments and/or various modification examples. It goes without saying that the technology is not limited to the embodiment described above, various configurations can be adopted as long as the configuration does not deviate from the gist. Furthermore, the technology of the present disclosure extends to a storage medium that non-transitorily stores the program, and a computer program product including the program, in addition to the program.

The above descriptions and illustrations are detailed descriptions of portions related to the technology of the present disclosure, and are merely examples of the technology of the present disclosure. For example, description related to the above configurations, functions, operations, and effects is description related to an example of configurations, functions, operations, and effects of the parts of the technology of the present disclosure. Therefore, it goes without saying that unnecessary portions may be deleted, new elements may be added, or replacement may be made to the above descriptions and illustrations without departing from the gist of the technology of the present disclosure. In order to avoid complications and facilitate grasping the parts of the technology of the present disclosure, in the above descriptions and illustrations, the description of technical general knowledge and the like that do not particularly require description for enabling the implementation of the technology of the present disclosure are omitted.

In the present specification, “A and/or B” is synonymous with “at least one of A or B”. That is, the term “A and/or B” may mean only A, only B, or a combination of A and B. In addition, in the present specification, also in a case where three or more matters are associated and expressed by “and/or”, the same concept as “A and/or B” is applied.

All documents, patent applications, and technical standards described in the present specification are incorporated herein by reference to the same extent as in a case in which each document, each patent application, and each technical standard are specifically and individually described by being incorporated by reference.

What is claimed is:

1. A focus control device comprising:
a processor configured to determine a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

2. The focus control device according to claim 1,
wherein the reference pixel and the neighboring pixel are arranged on the same line,
as the neighboring pixel, there are two neighboring pixels of one neighboring pixel located in a first direction of the line and one neighboring pixel located in a second direction opposite to the first direction with respect to the reference pixel, and
as the difference, there are
a first difference between the pixel value of the reference pixel and a pixel value of one of the two neighboring pixels, and
a second difference between the pixel value of the reference pixel and a pixel value of the other of the two neighboring pixels.

3. The focus control device according to claim 2,
wherein the two neighboring pixels are located symmetrically with respect to the reference pixel.

4. The focus control device according to claim 3,
wherein the reference pixel and the two neighboring pixels are adjacent to each other.

5. The focus control device according to claim 4,
wherein, in a case where the pixel value of the reference pixel is denoted by G(K+1), the pixel value of the one of the two neighboring pixels is denoted by G(K), the pixel value of the other of the two neighboring pixels is denoted by G(K+2), K is 0 to N−2, and N is a total number of the phase-difference detection pixels related to calculation of the difference,
the first difference is G(K+1)−G(K), and
the second difference is G(K+2)−G(K+1).

6. The focus control device according to claim 2,
wherein the processor is configured to determine the detection method in accordance with a combination of signs of the first difference and the second difference.

7. The focus control device according to claim 6,
wherein the processor is configured to determine whether a change in the pixel values of the reference pixel and the neighboring pixel forms a peak or a valley based on the combination.

8. The focus control device according to claim 7,
wherein the processor is configured to determine the detection method in accordance with the number of the reference pixels determined to have a first index value related to the first difference and the second difference larger than a first threshold value, the first index value being determined for the reference pixel and the neighboring pixel that are determined to have the change that forms the peak or the valley.

9. The focus control device according to claim 8,
wherein the first index value is a ratio between a larger value of the first difference and the second difference and a representative value of the difference.

10. The focus control device according to claim 8,
wherein the processor is configured to determine the detection method in accordance with a second index value related to the number.

11. The focus control device according to claim 10,
wherein the second index value is a ratio of the number to a total number of the phase-difference detection pixels related to calculation of the difference.

12. The focus control device according to claim 10,
wherein the processor is configured to
determine a level of a frequency component of the focus detection region based on a comparison result between the second index value and a second threshold value, and
determine the detection method in accordance with a determination result of the level.

13. The focus control device according to claim 12,
wherein the processor is configured to
detect the focus position in accordance with a first detection method in a case where the determination result indicates that a level of a high-frequency component of the focus detection region is relatively high, and
detect the focus position in accordance with a second detection method different from the first detection method in a case where the determination result indicates that a level of a low-frequency component of the focus detection region is relatively high.

14. The focus control device according to claim 13,
wherein the processor is configured to detect the focus position in accordance with the first detection method and the second detection method in a case where the determination result indicates that a level of a medium-frequency component of the focus detection region is relatively high.

15. The focus control device according to claim 13,
wherein there are a plurality of the first detection methods, and
the processor is configured to aggregate detection reference information of the plurality of first detection methods.

16. The focus control device according to claim 12,
wherein the processor is configured to
determine the level for each of a plurality of split regions obtained by splitting the focus detection region, and
determine the detection method for each of the plurality of split regions.

17. The focus control device according to claim 12,
wherein the processor is configured not to determine the level in a case where a set condition is satisfied.

18. The focus control device according to claim 17,
wherein the processor is configured not to determine the level in a case where a subject in the focus detection region is a set subject.

19. The focus control device according to claim 18,
wherein the set subject is a subject having a relatively high level of a high-frequency component.

20. The focus control device according to claim 17,
wherein the processor is configured not to determine the level in a case where the focus detection region smaller than a threshold size is set.

21. The focus control device according to claim 1,
wherein the pixel value of the reference pixel and the pixel value of the neighboring pixel are representative values of pixel values of the plurality of phase-difference detection pixels.

22. An operation method of a focus control device, the operation method comprising:
determining a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

23. A non-transitory computer-readable storage medium storing an operation program of a focus control device, the operation program causing a computer to execute a process comprising:
determining a detection method of a focus position of a focus lens in accordance with a difference for a plurality of phase-difference detection pixels arranged in a focus detection region, the difference being a difference between a pixel value of a reference pixel and a pixel value of a neighboring pixel present within a preset neighboring range from the reference pixel.

24. An imaging device comprising:
the focus control device according to claim 1.
